(19) United States
(12) Patent Application Publication
(10) Pub. No.: US 2025/0229944 A1
(43) Pub. Date: Jul. 17, 2025

(54) Modular Systems and Components

(71) Applicant: Milwaukee Electric Tool Corporation, Brookfield, WI (US)

(72) Inventors: Aaron M. Williams, Milwaukee, WI (US); Benjamin T. Jones, St. Francis, WI (US); Grant T. Squiers, Cudahy, WI (US); David R. Hillenbrand, Grafton, WI (US); Caleb C. Adams, Milwaukee, WI (US); Charlie G. Noble, New Berlin, WI (US); Jedidiah J. Babinec, Milwaukee, WI (US); Collin J. Nelson, Milwaukee, WI (US); Hunter M. Schwei, Milwaukee, WI (US); George Barton, Mequon, WI (US); Tanner C. Mascarenas, Milwaukee, WI (US); Christian R. Braun, Milwaukee, WI (US); Van N. Heyer, Milwaukee, WI (US); Alec C. Roberts, Milwaukee, WI (US); Christopher S. Spaulding, Milwaukee, WI (US); Matthew D. Post, Hartland, WI (US); Sebastien A. Hughes, Long Valley, NJ (US)

(21) Appl. No.: 19/025,285

(22) Filed: Jan. 16, 2025

Related U.S. Application Data
(63) Continuation of application No. PCT/US2025/010957, filed on Jan. 9, 2025.
(60) Provisional application No. 63/620,307, filed on Jan. 12, 2024.

(51) Int. Cl. B65D 21/02

(52) U.S. Cl. CPC B65D 21/0223

(57) ABSTRACT

Various components for use within a modular system are provided. In various embodiments, the coupling systems provided herein facilitate coupling modular units, such as by providing multiple sliding directions or mechanisms to couple different units. Also provided are systems for communicating between modular units, such as by providing information and/or power between modular units.

### CROSS-REFERENCE TO RELATED PATENT APPLICATIONS

The present application is a continuation of International Application No. PCT/US2025/010957, filed Jan. 9, 2025, which claims the benefit of and priority to U.S. Provisional Application No. 63/620,307 filed on Jan. 12, 2024, each of which is incorporated herein by reference in its entirety.

### BACKGROUND OF THE INVENTION

The present invention relates generally to the field of modular systems. The present invention relates specifically to components and utility modules within various modular systems.

### SUMMARY OF THE INVENTION

One embodiment of the invention relates to a coupler for utility modules including a front wall configured to engage against a front surface of a rail, the rail extending longitudinally, an upper arm extending from the front wall, a rear higher arm extending from the second end of the upper arm, and a clip pivotally coupled to the front wall. The upper arm is configured to engage against an upper surface of the rail that is above and extends from the front surface of the rail, the upper arm extending from a first end at the front wall to a second end opposite the first end. The rear higher arm, the upper arm, and the front wall collectively define an upper channel within which an upper portion of the rail slides with respect to the front wall. The clip actuates with respect to the front wall between a locked position and an unlocked position. The clip includes a projection that engages within a recess defined by the front surface of the rail when the clip is in the locked position, and the clip biases the front wall from sliding with respect to the rail when the clip is in the locked position.

Another embodiment of the invention relates to a coupler for utility modules including a front wall configured to engage against a front surface of a rail, the rail extending longitudinally, an upper arm extending from the front wall, a rear higher arm extending from the second end of the upper arm, and a clip pivotally coupled to the front wall. The upper arm is configured to engage against an upper surface of the rail that is above and extends from the front surface of the rail, the upper arm extending from a first end at the front wall to a second end opposite the first end. The rear higher arm, the upper arm, and the front wall collectively define a channel within which the rail slides with respect to the front wall, the upper arm, and the rear higher arm. The clip actuates with respect to the front wall between a locked position and an unlocked position. The clip includes a body and an arm extending from the body, the body defining a cam surface. The body and the arm rotate about a first axis with respect to the front wall when the clip pivots with respect to the front wall, and the cam surface interfaces against the front surface of the rail when the clip is in the locked position, and the clip biases the front wall from sliding with respect to the rail when the clip is in the locked position.

Another embodiment of the invention relates to a coupler for utility modules including a front wall configured to engage against a front surface of a rail, the rail extending longitudinally, an upper arm extending from the front wall, and a plurality of ribs extending from second end. The upper arm is configured to engage against an upper surface of the rail that is above and extends from the front surface of the rail, the upper arm extending from a first end at the front wall to a second end opposite the first end. The plurality of ribs are configured to engage with recesses defined by the rail to bias the front wall from sliding with respect to the rail.

Another embodiment of the invention relates to a system including a first utility module and a second utility module. The first utility module includes channels defined by an upper surface, and the second utility module includes cleats extending from a lower surface. The first utility module and the second utility module can be detachably coupled by sliding the first utility module with respect to the second utility module in a first direction. The first utility module and the second utility module can be detachably coupled by sliding the first utility module with respect to the second utility module in a second direction perpendicular to the first direction.

In a specific embodiment, the first utility module and the second utility module can be detachably coupled by sliding the first utility module with respect to the second utility module in a third direction opposite the first direction. In a specific embodiment, the first utility module and the second utility module can be detachably coupled by sliding the first utility module with respect to the second utility module in a fourth direction opposite the second direction.

Another embodiment of the invention relates to a system including a first utility module and a second utility module. The first utility module includes a first electrical interface that provides electrical power to a second electrical interface of the second utility module when the first and second utility modules are detachably coupled together. In a specific embodiment, the first utility module includes a latch recess that receives a latch from the second utility module, the latch preventing sliding disengagement between the first and second utility modules and the latch receiving power from the second utility module.

Additional features and advantages will be set forth in the detailed description which follows, and will be readily apparent to those skilled in the art from the description or recognized by practicing the embodiments as described in the written description and/or shown in the accompanying drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of utility modules in a modular system, according to an exemplary embodiment.

FIG. 2 is a perspective view of the modular system of FIG. 1, according to an exemplary embodiment.

FIG. 3 is a schematic side view of a portion of the modular system of FIG. 1, according to an exemplary embodiment.

FIG. 4 is a perspective view of utility modules in a modular system, according to another exemplary embodiment.

FIG. 5 is a perspective view of a portion of the modular system of FIG. 4, according to an exemplary embodiment.

FIG. 6 is a perspective view of a portion of the modular system of FIG. 4, according to an exemplary embodiment.

FIG. 7 is a perspective view of a utility module, according to another exemplary embodiment.

FIG. 8 is a perspective view of a utility module, according to another exemplary embodiment.

FIG. 9 is a perspective view of a utility module, according to another exemplary embodiment.

FIG. 10 is a schematic view of the utility module of FIG. 7 and utility modules of FIG. 9, according to an exemplary embodiment.

FIG. 11 is a schematic view of the utility module of FIG. 7 and the utility module of FIG. 9, according to an exemplary embodiment.

FIG. 12 is a perspective view of utility modules in a modular system, according to another exemplary embodiment.

FIG. 13 is a perspective view of a portion of the modular system of FIG. 12, according to an exemplary embodiment.

FIG. 14 is a perspective view of a portion of the modular system of FIG. 12, according to an exemplary embodiment.

FIG. 15 is a schematic view of couplers in a modular system, according to another exemplary embodiment.

FIG. 16 is a perspective view of a portion of the couplers of the modular system of FIG. 15, according to an exemplary embodiment.

FIG. 17 is a perspective view of a portion of the couplers of the modular system of FIG. 15, according to an exemplary embodiment.

FIG. 18 is a perspective view of a portion of the couplers of the modular system of FIG. 15, according to an exemplary embodiment.

FIG. 19 is a perspective view of a portion of the couplers of the modular system of FIG. 15, according to an exemplary embodiment.

FIG. 20 is a perspective view of a portion of first coupler in a modular system, according to another exemplary embodiment.

FIG. 21 is a perspective view of a portion of a second coupler of the modular system of FIG. 20, according to an exemplary embodiment.

FIG. 22 is a perspective view of utility modules in a modular system, according to another exemplary embodiment.

FIG. 23 is a schematic side view of the modular system of FIG. 22, according to an exemplary embodiment.

FIG. 24 is a perspective view of a utility module, according to another exemplary embodiment.

FIG. 25 is a perspective view of the utility module of FIG. 24, according to an exemplary embodiment.

FIG. 26 is a perspective view of a utility module, according to another exemplary embodiment.

FIG. 27A is a perspective view of the utility module of FIG. 26, according to an exemplary embodiment.

FIG. 27B is a perspective view of a portion of the utility module of FIG. 26, according to an exemplary embodiment.

FIG. 27C is a perspective view of a portion of the utility module of FIG. 26, according to an exemplary embodiment.

FIG. 28 is a perspective view of a utility module, according to another exemplary embodiment.

FIG. 29 is a perspective view of the utility module of FIG. 28, according to an exemplary embodiment.

FIG. 30 is a schematic view of a coupler of a modular system, according to another exemplary embodiment.

FIG. 31 is a perspective view of a coupler of the modular system of FIG. 30, according to an exemplary embodiment.

FIG. 32 is a front view of a utility module, according to another exemplary embodiment.

FIG. 33 is a perspective view of the utility module of FIG. 32, according to an exemplary embodiment.

FIG. 34 is a perspective view of the utility module of FIG. 32, according to an exemplary embodiment.

FIG. 35 is a perspective view of the utility module of FIG. 32, according to an exemplary embodiment.

FIG. 36 depicts a component of another modular system, according to an exemplary embodiment.

FIG. 37 is a perspective view of a coupler of a utility module, according to another exemplary embodiment.

FIG. 38 is a perspective view of a coupler of the utility module of FIG. 37, according to an exemplary embodiment.

FIG. 39 is a schematic side view of the couplers of FIGS. 37 and 38, according to an exemplary embodiment.

FIG. 40 is a perspective view of components of a modular system, according to another exemplary embodiment.

FIG. 41 is a perspective view of a portion of the modular system of FIG. 40, according to an exemplary embodiment.

FIG. 42 is a perspective view of a modular system, according to another exemplary embodiment.

FIG. 43 is a perspective view of the modular system of FIG. 42, according to an exemplary embodiment.

FIG. 44 is a front view of a utility module, according to another exemplary embodiment.

FIG. 45 is a front view of the utility module of FIG. 44, according to an exemplary embodiment.

FIG. 46 is a perspective view of a modular system including the utility module of FIG. 44, according to an exemplary embodiment.

FIG. 47 is a perspective view of a modular system, according to another exemplary embodiment.

FIG. 48 is a perspective view of the modular system of FIG. 47, according to an exemplary embodiment.

FIG. 49 is a perspective view of the modular system of FIG. 47, according to an exemplary embodiment.

FIG. 50 is a schematic view of the modular system of FIG. 47, according to an exemplary embodiment.

FIG. 51 is a schematic view of the modular system of FIG. 47, according to an exemplary embodiment.

FIG. 52 is a perspective view of a modular system, according to another exemplary embodiment.

FIG. 53 is a perspective view of the modular system of FIG. 52, according to an exemplary embodiment.

FIG. 54 is a schematic view of the modular system of FIG. 52, according to an exemplary embodiment.

FIG. 55 is a perspective view of a modular system, according to another exemplary embodiment.

FIG. 56 is a perspective view of the modular system of FIG. 55, according to an exemplary embodiment.

FIG. 57 is a schematic view of the modular system of FIG. 55, according to an exemplary embodiment.

FIG. 58 is a schematic view of the modular system of FIG. 55, according to an exemplary embodiment.

FIG. 59 is a perspective view of a portion of the modular system of FIG. 55, according to an exemplary embodiment.

FIG. 60 depicts a perspective view of components in another modular system, according to an exemplary embodiment.

FIG. 61 is a perspective view of a portion of a modular system, according to another exemplary embodiment.

FIG. 62 is a side view of the modular system of FIG. 61, according to an exemplary embodiment.

FIG. 63 is a perspective view of a portion of a modular system, according to another exemplary embodiment.

FIG. 64 is a perspective view of a portion of the modular system of FIG. 63, according to an exemplary embodiment.

FIG. 65 is a schematic side view of a portion of the modular system of FIG. 63, according to an exemplary embodiment.

FIG. 66 is a perspective view of a portion of a modular system, according to another exemplary embodiment.

FIG. 67 is a perspective view of a portion of a modular system, according to another exemplary embodiment.

FIG. 68 is a perspective view of a portion of a modular system, according to another exemplary embodiment.

FIG. 69 is a perspective view of a portion of a modular system, according to another exemplary embodiment.

FIG. 70 is a perspective view of a portion of a modular system, according to another exemplary embodiment.

FIG. 71 is a perspective view of a portion of a modular system, according to another exemplary embodiment.

FIG. 72 is a perspective view of a portion of a modular system, according to another exemplary embodiment.

FIG. 73 is a schematic view of a portion of the modular system of FIG. 72, according to an exemplary embodiment.

FIG. 74 depicts a perspective view of utility modules in another modular system, according to an exemplary embodiment.

FIG. 75 is a side view of a modular system, according to another exemplary embodiment.

FIG. 76 is a perspective view of the modular system of FIG. 75, according to an exemplary embodiment.

FIG. 77 is a perspective view of the modular system of FIG. 75, according to an exemplary embodiment.

FIG. 78 is a perspective view of a portion of the modular system of FIG. 75, according to an exemplary embodiment.

FIG. 79 is a schematic side view of a portion of the modular system of FIG. 75, according to an exemplary embodiment.

FIG. 80 is a perspective view of a portion of a modular system, according to another exemplary embodiment.

FIG. 81 is a side schematic view of a portion of the modular system of FIG. 80, according to an exemplary embodiment.

FIG. 82 is a perspective view of the modular system of FIG. 80, according to an exemplary embodiment.

FIG. 83 is a schematic view of a modular system, according to another exemplary embodiment.

FIG. 84 is a schematic view of the modular system of FIG. 83, according to an exemplary embodiment.

FIG. 85 is a perspective schematic view of utility modules in another modular system, according to an exemplary embodiment.

FIG. 86 is a side view of a portion of a modular system, according to another exemplary embodiment.

FIG. 87 is a perspective view of a portion of the modular system of FIG. 86, according to an exemplary embodiment.

FIG. 88 is a side view of a portion of a modular system, according to another exemplary embodiment.

FIG. 89 is a perspective view of a portion of the modular system of FIG. 88, according to an exemplary embodiment.

FIG. 90 is a side schematic view of utility modules in another modular system, according to an exemplary embodiment.

FIG. 91 is a perspective view of a portion of a modular system, according to another exemplary embodiment.

FIG. 92 is a perspective view of a portion of the modular system of FIG. 91, according to an exemplary embodiment.

FIG. 93 is a perspective view of a portion of a modular system, according to another exemplary embodiment.

FIG. 94 is a perspective view of a portion of the modular system of FIG. 93, according to an exemplary embodiment.

FIG. 95 is a perspective view of a portion of a modular system, according to another exemplary embodiment.

FIG. 96 is a perspective view of a portion of the modular system of FIG. 95, according to an exemplary embodiment.

FIG. 97 depicts a perspective schematic view of a utility module and component in another modular system, according to an exemplary embodiment.

FIG. 98 is a perspective view of a portion of a modular system, according to another exemplary embodiment.

FIG. 99 is a schematic view of a portion of the modular system of FIG. 98, according to an exemplary embodiment.

FIG. 100 depicts a perspective schematic view of a storage system, according to an exemplary embodiment.

FIG. 101 is a perspective view of a portion of a modular system, according to another exemplary embodiment.

FIG. 102 is a perspective view of a portion of the modular system of FIG. 101, according to an exemplary embodiment.

FIG. 103 is a display of a portion of the modular system of FIG. 101, according to an exemplary embodiment.

FIG. 104 is a display when using a storage system in another modular system, according to an exemplary embodiment.

FIG. 105 is a perspective view of a portion of a modular system, according to another exemplary embodiment.

FIG. 106 is a perspective view of a portion of the modular system of FIG. 105, according to an exemplary embodiment.

FIG. 107 is a schematic view of a portion of a modular system, according to another exemplary embodiment.

FIG. 108 is a schematic view of a portion of the modular system of FIG. 107, according to an exemplary embodiment.

FIG. 109 is a schematic view of a portion of the modular system of FIG. 107, according to an exemplary embodiment.

FIG. 110 is a schematic view of a portion of the modular system of FIG. 107, according to an exemplary embodiment.

FIG. 111 is a perspective view of a portion of a modular system, according to an exemplary embodiment.

FIG. 112 is a perspective schematic view of a portion of a modular system, according to another exemplary embodiment.

FIG. 113 is a perspective view of a portion of the modular system of FIG. 112, according to an exemplary embodiment.

FIG. 114 is a schematic side view of a portion of the modular system of FIG. 112, according to an exemplary embodiment.

FIG. 115 is a perspective schematic view of a component of a storage unit in another modular system, according to an exemplary embodiment.

FIG. 116 is a schematic side view of a component for use with modular systems, according to an exemplary embodiment.

FIG. 117 is a schematic view of a support structure, according to an exemplary embodiment.

FIG. 118 is a schematic side view of a support structure, according to an exemplary embodiment.

FIG. 119 is a perspective schematic view of a support structure, according to an exemplary embodiment.

FIG. 120 is a schematic side view of a coupling mechanism, according to an exemplary embodiment.

### DETAILED DESCRIPTION

Referring generally to the figures, various embodiments of various support structure and utility modules, such as support structure and utility modules are provided for use within one or more modular systems. Various embodiments described herein relate to coupling systems that provide for flexible coupling between utility modules, such as different sized modules being coupled together and/or utility modules being able to be coupled in multiple orientations with respect to each other. Various embodiments described herein relate to coupling systems for modular systems, such as coupling systems including sliding and/or rotating components that engage with the other utility module.

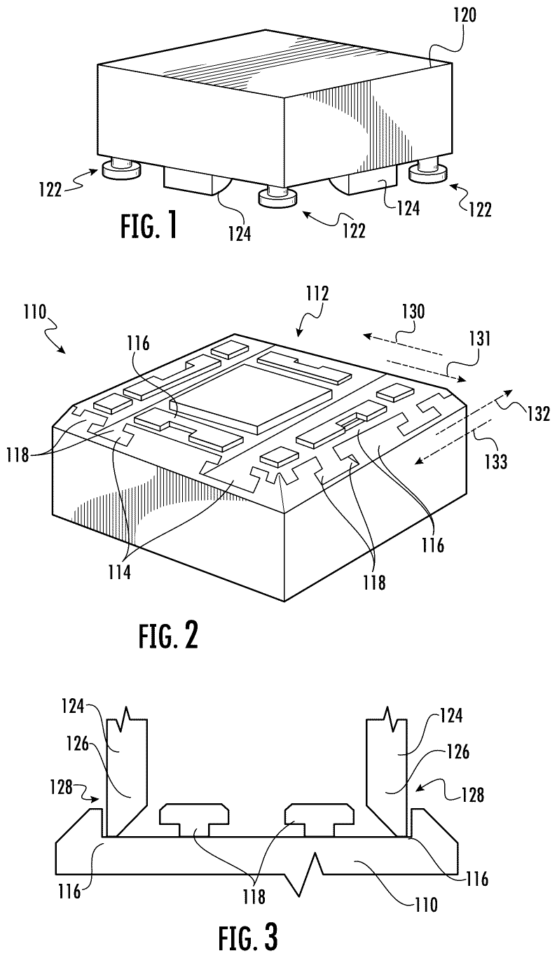

Referring to FIGS. 1-3, various aspects of a system including utility modules 110, 120 are shown. Utility module 110 includes upper surface 112, channels 114 defined within upper surface 112, latch recess 116 defined within upper surface 112, and upper cleats 118. Utility module 120 includes cleats 122 extending from a bottom of utility module 120, and latch 124 coupled to and extending from a bottom of utility module 120. Referring to FIG. 3, latch 124 includes cammed surface 126 to facilitate slidingly engaging utility module 120 and utility module 110, and latch 124 includes flat surface 128 to bias utility module 120 and utility module 110 to remain engaged.

In use, utility module 120 is slid with respect to utility module 110 until cleats 122 of utility module 120 are within channels 114 and below cleats 118 of utility module 110. Latch 124 that is on the leading side of the sliding direction (e.g., directions 130, 131, 132, 133) is retracted upward by the user and/or via the leading latch 124 being forced upward by interaction with utility module 110. The trailing latch 124 is automatically retracted by the interface between utility module 120 and utility module 110. In particular, cammed surface 126 of latch 124 interfaces with utility module 110 to actuate latch 124 upward towards body of utility module 120 until latch 124 is permitted to extend downward such that flat surface 128 of latch 124 interfaces with utility module 110 (FIG. 3), thereby biasing utility module 120 from slidingly disengaging from utility module 110.

In various embodiments, utility module 120 can slide in any of directions 130, 131, 132, 133 to slidingly engage with utility module 110. In various embodiments, utility modules 110, 120 both include channels, latch recesses and cleats on the upper surface and cleats and latches on the lower surface. In a specific embodiment, utility module 110 can be slid in direction 130 to detachably couple to utility module 120, in direction 132 perpendicular to direction 130 to detachably couple to utility module 120, in direction 131 opposite direction 130 to detachably couple to utility module 120, and direction 133 opposite direction 132 to detachably couple to utility module 120.

In various embodiments, a coupler (e.g., coupler 1180 coupled to rail 1112 coupled to utility module 120) is supported from a first utility module 120 configured to detachably and rigidly couple with a second utility module 110 when the first utility module 120 slides in a first direction 130, and the first utility module 120 is configured to detachably and rigidly couple with the second utility module 110 when the first utility module slides in a second direction 132 perpendicular to the first direction, and the first utility module 120 and the second utility module 110 detachably and rigidly couple via cleats 122 extending from the first utility module 120 engaging with channels 114 defined by the second utility channel 110.

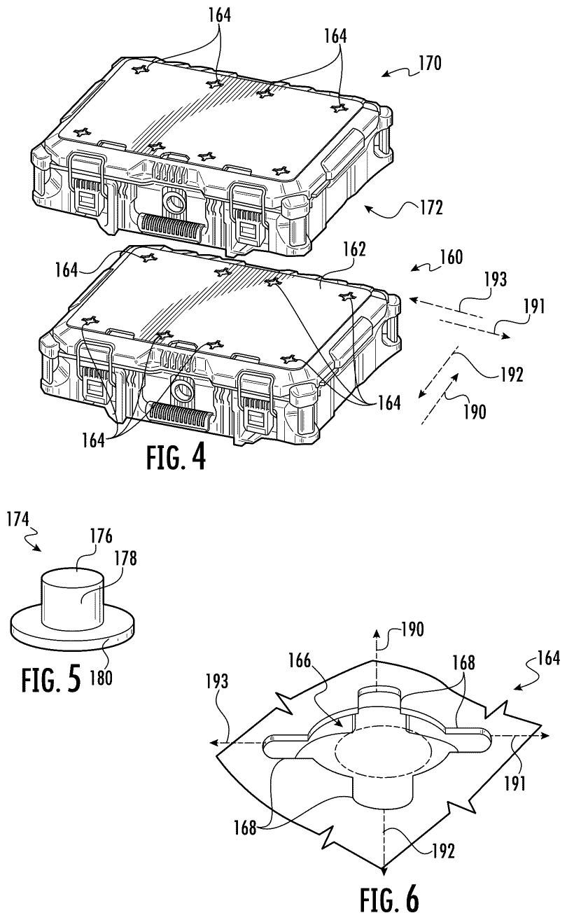

Referring to FIGS. 4-6, various aspects of utility modules 160, 170 are shown. Utility module 160 and utility module 170 slidingly engage and disengage with each other in a stacked position. Utility module 160 includes upper surface 162, which includes one or more female couplers 164. Utility module 170 includes lower surface 172 and one or more male couplers 174 extending from lower surface 172. Male couplers 174 include upper end 176 of body 178 extending from lower surface 172 towards lip 180.

To detachably couple utility module 160 and utility module 170 together, lip 180 and body 178 of male coupler(s) 174 are vertically lowered into central portion 166 of female coupler(s) 164. Then, utility module 160 and utility module 170 are slid with respect to each other in one of four directions (e.g., in one of directions 190, 191, 192, 193) until body 178 of male coupler(s) 174 is within one of recesses 168 of female coupler(s) 164 such that lip 180 prevents utility module 160 and utility module 170 from vertically disengaging. In various embodiments utility module 160 and/or utility module 170 includes a latch and latch recess to prevent sliding disengagement of utility module 160 and utility module 170, thereby keeping utility module 160 and utility module 170 rigidly coupled to each other. In various embodiments, utility modules 170 includes the same or a similar upper surface as utility module 160, and utility module 160 includes the same or a similar lower surface as utility module 170.

In various embodiments, the utility module (e.g., utility module 170) being coupled to the top of utility module 160 can be oriented in any of four orientations (e.g., directions 190, 191, 192, 193) so that the front of the utility module, such as the wall including the handle, the toggle locking latch(es) and/or the front of the lid, is facing in any of directions 190, 191, 192, 193. In various embodiments, the utility module (e.g., utility module 170) being coupled to the top of utility module 160 can couple to one of female couplers 164 (e.g., any one of female couplers 164), two female couplers 164 (any two neighboring female couplers 164), four female couplers 164, or eight female couplers 164.

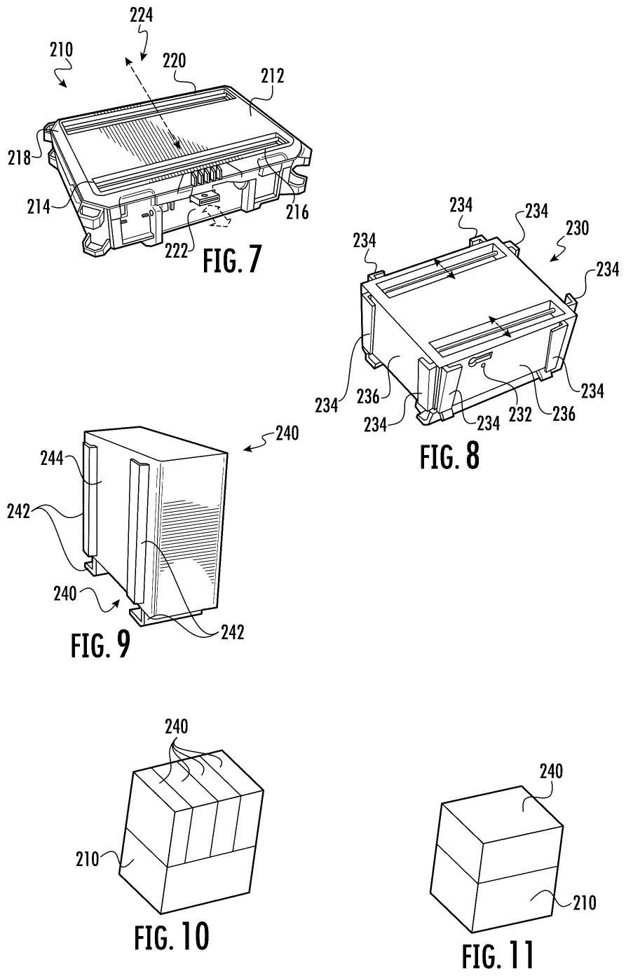

Referring to FIGS. 7-11, various aspects of utility modules are shown. Utility module 210 includes upper surface 212, front channel 214 defined by upper surface 212, first rail 216 extending into front channel 214, rear channel 218 defined by upper surface 212, second rail 220 extending into rear channel 218, and latch 222. A user actuates latch 222 to slide first rail 216 and/or second rail 220 along axis 224.

Referring to FIG. 8, utility module 230 includes the same structure and functionality as utility module 210 except as otherwise described. Utility module 230 includes latch 232 that actuates rail(s) (e.g., slides) on the upper surface, and one or more of faces 236 of utility module 230 includes cleats 234 extending from the face 236. In various embodiments, cleats 234 on each face 236 include a lip extending toward the other cleat 234 on the same face 236. In use, the lips of one utility module slidingly engage with the rail(s) of another utility module to detachably couple the utility modules.

Referring to FIG. 9, utility module 230 includes the same structure and functionality as utility module 210 or utility module 230 except as otherwise described. Utility module 240 includes cleats 242 extending from one or more faces 244 of utility module 240. In various embodiments, cleats 242 on each face 244 include a lip extending in the same direction as the other cleat 242 on the same face 244.

Referring to FIGS. 10-11, utility modules 240 can be coupled to upper surface 212 of utility module 210 in more than one configuration. In a first configuration (FIG. 10), utility modules 240 are stacked parallel to each other such that each utility module 240 is coupled to a portion of utility module 210, thereby allowing multiple (e.g., four) utility modules 240 to be rigidly coupled to a single surface of utility module 210. In a second configuration (FIG. 11), utility module 240 is stacked in the same orientation as utility module 210, and as a result a single utility module 240 is stacked to and above utility module 210.

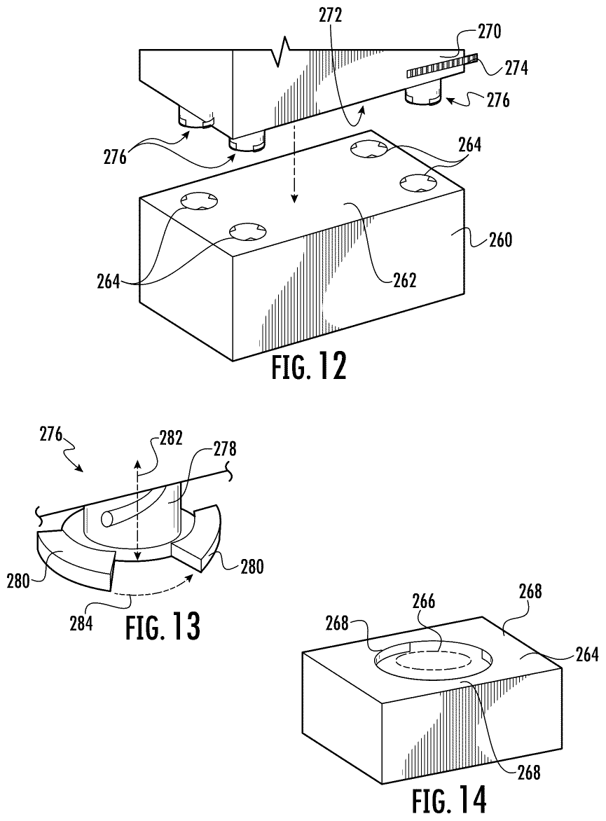

Referring to FIGS. 12-14, various aspects of utility module(s) 260, 270 are shown. Utility module 260 includes upper surface 262, which includes one or more female couplers 264. Female couplers 264 include a central portion 266 configured to receive a male coupler, and lips 268 extending circumferentially around central portion 266, the lips 268 configured to engage with male couplers to couple utility modules 260, 270.

Utility module 270 includes lower surface 272, male coupler(s) 276 extending from lower surface 272, and latch 274 coupled to body of utility module 270, the latch 274 configured to rotatably actuate male couplers 276. Male couplers 276 include body 278 extending downward, and tongues 280 extending radially away from body 278. When a user actuates latch 274, male couplers 276 rotate in direction 284 around axis 282 with respect to body of utility module 270.

To engage the utility modules, a user lowers utility module 270 onto utility module 260 such that one or more male couplers 276 are placed within a corresponding one or more female couplers 264. The user actuates latch 274 to rotate male couplers 276, and as a result tongues 280 of male couplers 276 are engaged below lips 268 of female couplers 264.

To disengage the utility modules, a user actuates latch 274 to rotate male couplers 276 opposite direction 284 around axis 282, thereby disengaging male couplers 276 from female couplers 264. As a result, the user can vertically slide apart utility modules 260, 270 from each other.

In various embodiments, both utility modules include both female couplers 264 and male couplers 276.

In various embodiments, a coupler (e.g., coupler 1180 coupled to rail 1112 coupled to utility module 120) is supported from a first utility module 270 configured to detachably and rigidly couple with a second utility module 260 via male couplers 276 extending from a lower surface 272 of the first utility module 270 rotatably engaging with female couplers 264 defined by an upper surface 262 of the second utility module 260.

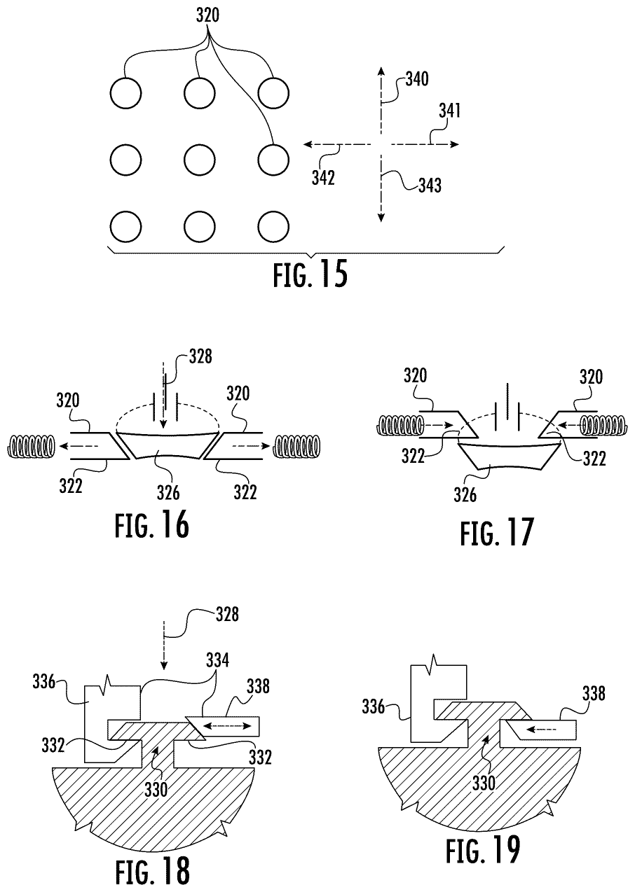

Referring to FIGS. 15-19, various aspects of couplers, such as for a module system, are shown. On a face of a first utility module (e.g., a tool storage unit), a plurality of female couplers 320 are arranged, such as in a grid arrangement. Each female coupler 320 includes one or more ribs 322 that are slidingly coupled to the utility module and one or more of the ribs 322 are spring-biased towards each other.

In use, male coupler 326 is moved in direction 328 with respect to the female coupler 320, and one or more of the ribs 322 is biased away from the other rib (FIG. 17) until the male coupler 326 is below the ribs 322 of the female coupler, thereby detachably engaging the female coupler 320 and the male coupler 326. In various embodiments, female couplers 320 include four ribs, one each at the top, bottom, left, and right, and one or more of the ribs are fixed and the remaining ribs are slidingly coupled to the utility module and spring-biased towards each other. In this way, female coupler 320 permits male couplers to be engaged to female couplers in any of four orientations (e.g., where front of the utility module including the male couplers faces in direction 340, rotated 90 degrees where front of the utility module faces in direction 341, rotated another 90 degrees where front faces in direction 342, or rotated another 90 degrees where front faces in direction 343).

Referring R to FIGS. 18-19, various aspects of couplers for another modular system are shown. Male coupler 330 includes ledges 332 that extend above the surface that male coupler 330 extends from. Female coupler 334 is moved in direction 328. Fixed rib 336 of female coupler 334 does not move with respect to the utility module of female coupler 334, and slidable rib 338 is biased by ledges 332 away from fixed rib 336 until female coupler 334 is engaged around male coupler 330 (FIG. 19), thereby detachably coupling the utility modules that the couplers are extending from.

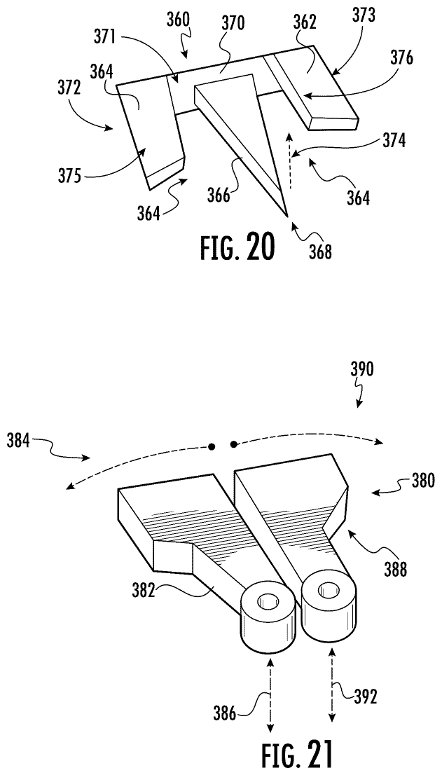

Referring to FIGS. 20-21, various aspects of couplers for utility module(s) for another modular system are shown. Female coupler 360 includes tongues 362 extending above recessed surface 364. As will be explained, tongues 362 engage with rib(s) of male coupler 380. Female coupler 360 includes a projection 366 extending upward from recessed surface 364, starting from first end 368 and expanding towards second end 370.

Male coupler 380 includes left rib 382 and right rib 388. In use, male coupler 380 is slid towards back of female coupler 360 until left rib 382 and right rib 388 engage with projection 366. Left rib 382 is biased by projection 366 to pivot in direction 384 around axis 386, and right rib 388 is biased by projection 366 to pivot in direction 390 around axis 392, thereby detachably engaging left and right ribs 382, 388 and tongue 362. In various embodiments, left rib 382 and right rib 388 are spring-biased towards each other (e.g., left rib 382 is spring-biased opposite direction 384 and right rib 388 is spring-biased opposite direction 390). Thus, as male coupler 380 is removed from female coupler 360, left and right ribs 382, 388 are spring-biased to retract away from being under tongues 362, thereby disengaging the couplers.

In various embodiments a coupling assembly includes female coupler 360 and male coupler 380. Female coupler 360 is located at a face of the first utility module, and male coupler 380 is located at a face of a second utility module. The female coupler 360 includes depressed locking surface 364, a back wall 371, first side wall 372, and a second side wall 373 extending from the depressed locking surface 364 in a first direction 374. First tongue 375 extends from the first side wall 372 and the back wall 371 above the depressed locking surface 364, and second tongue 376 extends from the second side wall 373 and the back wall 371 above the depressed locking surface 364. Projection 366 extends from the depressed locking surface 364 in the first direction 374 between the first tongue 375 and the second tongue 376.

Male coupler 380 is configured to detachably engage with the female coupler 360 such that the first utility module and the second utility module are detachably and rigidly engaged. Male coupler 380 includes a first rib 382 rotatably coupled to the second utility module such that the first rib 382 rotates with respect to the second utility module about a first axis 386, and a second rib 388 rotatably coupled to the second utility module such that the second rib 388 rotates with respect to the second utility module about a second axis 392 distinct from the first axis 386. When the male coupler 380 is engaged with the female coupler 360 the projection 366 biases the first rib 382 between the first tongue 375 and the depressed locking surface 364 and the projection 366 biases the second rib 388 between the second tongue 376 and the depressed locking surface 364.

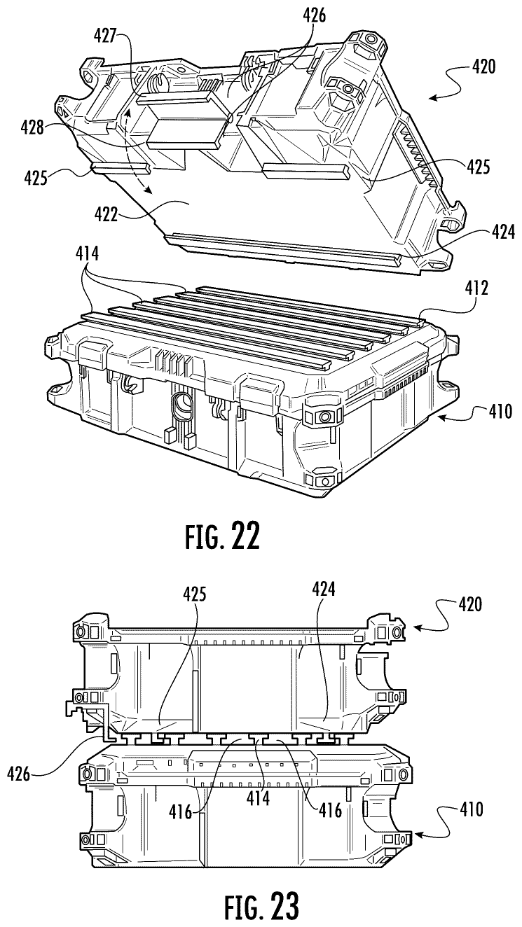

Referring to FIGS. 22-23, various aspects of utility module(s) are shown. Utility module 410 includes upper surface 412 that includes rails 414, and lips 416 extending from rails 414 above upper surface 412. Utility module 420 includes lower surface 422, rear rail 424 and front rails 425 extending from lower surface 422, and movable rail(s) 426 extending from lower surface 422. Movable rail(s) 426 actuate between a first position 427 and a second position 428, and in the second position movable rail 426 secures utility module 420 to utility module 410, such as by biasing utility module 420 from sliding forward, thereby securing the engagement between rails 414 of utility module 410 and rails 424, 425 of utility module 420. In various embodiments, both utility modules include rails 424 extending from upper surface and rails 424, 426.

In various embodiments, front rails 425 includes ribs extending both forward and backward, thereby forming a T-shaped cross-section similar to rear rail 424 (see FIG. 23).

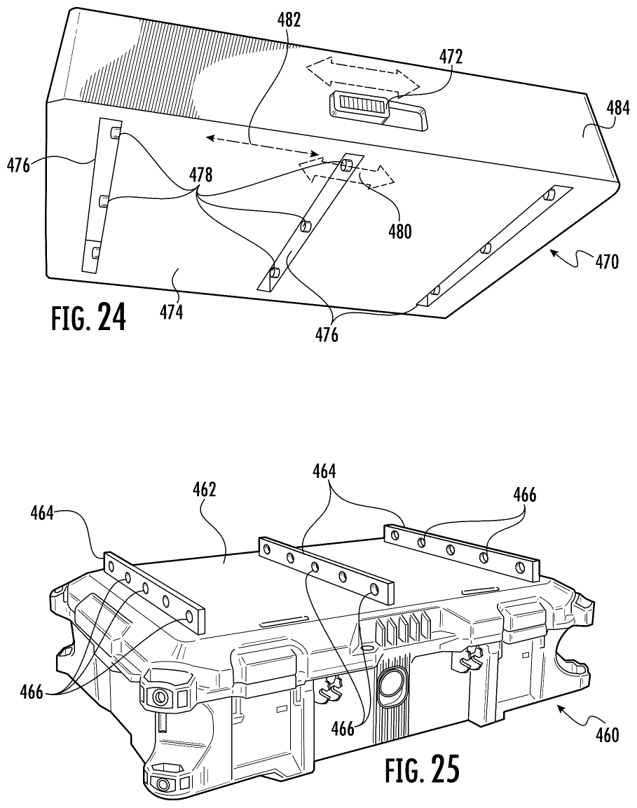

Referring to FIGS. 24-25, various aspects of utility module(s) are shown. Utility module 460 includes upper surface 462, rails 464 extending from upper surface 462, and apertures 466 defined by rails 464. Utility module 470 includes latch 472, lower surface 474, recesses 476 defined by lower surface 474, pins 478 extending within recesses 476. One or more of pins 478, such as first pin 480, slide with respect to housing 484 of utility module 470 along axis 482.

In use, utility module 460 is placed on utility module 470. One or more of pins 478 include a cammed surface to bias the pins 478 into housing 484 as utility module 460 is placed on utility module 470 until pins 478 are aligned with apertures 466. In various embodiments, pins 478 are spring-biased towards being fully extended into recesses 476. When pins 478 are aligned with apertures 466, pins 478 engage within apertures 466, thereby rigidly coupling utility module 460 and utility module 470.

In various embodiments, utility module 460 includes two rails 464, or four rails 464, or six rails 464, or eight rails 464, thereby permitting half-size utility modules to be coupled together (e.g., the half-size utility module may engage with only one half of the couplers of the full size utility module). In various embodiments, both utility modules include both rails extending from an upper surface and recesses defined by the lower surface.

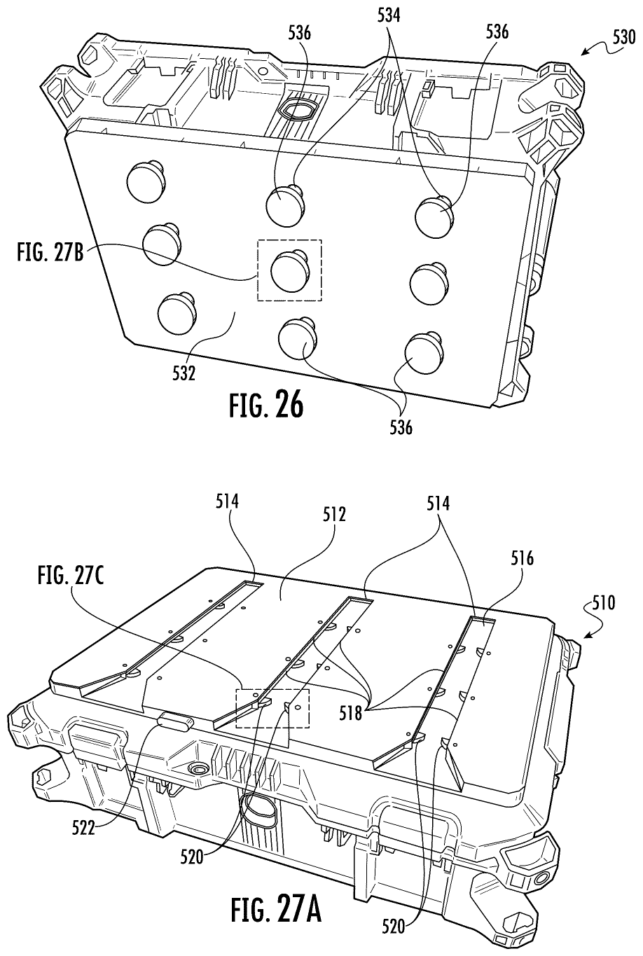

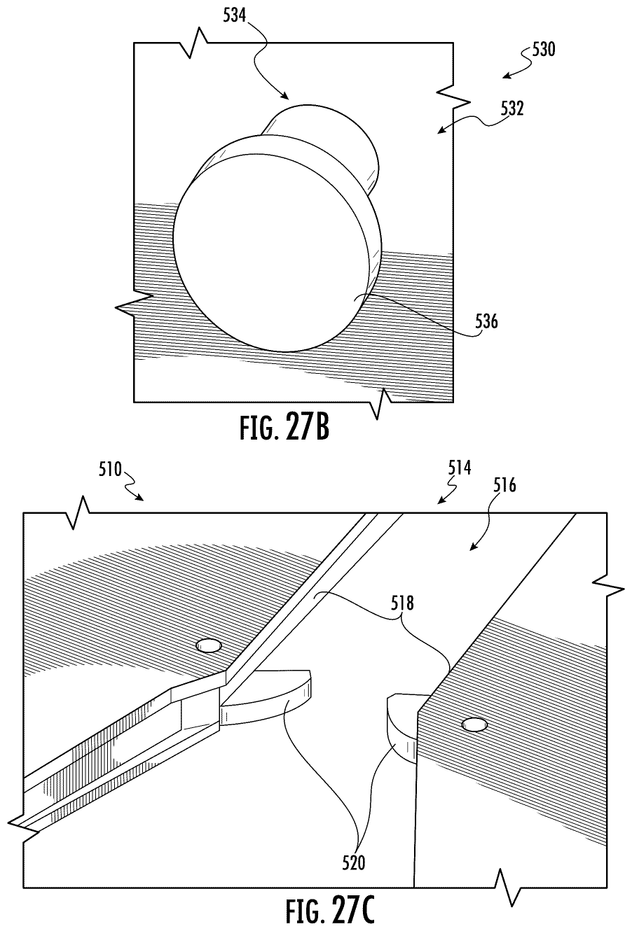

Referring to FIGS. 26-27C, various aspects of utility module(s) are shown. Utility module 510 includes upper surface 512, and channels 514 defined by upper surface 512. Channels 514 include recessed surface 516 below ledges 518 of channels 514. In various embodiments, ledges 518 extend above, offset from and parallel to recessed surface 516. One or more projections 520 extend within channels 514. Projections 520 slidingly actuate between being fully extended within channels 514 and being partially or fully retracted from channels 514. When pressed by a user, latch 522 actuates projections 520 from the fully extended position into the partially or fully retracted position.

Utility module 530 includes lower surface 532, protrusions 534 extending from lower surface 532, and tab 536 extending from protrusions 534. In various embodiments, tab 536 extends below, offset from and parallel to lower surface 532. In use, tab 536 extends below ledges 518 of channel 514 to couple utility module 530 to utility module 510. When the projections 520 fully extend into channels 514, the projections 520 bias tabs 536 from sliding past projections 520 and being removed from channels 514, thereby detachably coupling utility module 530 and utility module 510.

In various embodiments, projections 520 are spring-biased to extend into channels 514. In use, when utility module 530 is being coupled to utility module 510, tabs 536 can be inserted into channel 514 via tabs 536 biasing projections 520 to be retracted until tabs 536 are past the projections 520. In use, when utility module 530 is being decoupled from utility module 510, a user depresses latch 522, thereby retracting projections 520, which allows tabs 536 to be remove from channel 514.

In various embodiments, utility module 510 includes two channels 514, or four channels 514, or six channels 514, or eight channels 514, and utility module 530 includes a corresponding number of rows of protrusions 534. In various embodiments, both utility modules include both channels on upper surface and rows of protrusions on lower surfaces.

In various embodiments, a coupler (e.g., coupler 1180 coupled to rail 1112 coupled to utility module 120) is supported from a first utility module 530 configured to detachably and rigidly couple with a second utility module 510 via protrusions 534 extending from a lower surface 532 of the first utility module slidably 530 engaging with channels 514 defined by an upper surface 512 of the second utility module 510, the channels 514 including a plurality of projections 520 retractably extending into the channels 514, the plurality of projections 520 configured to bias the protrusions 534 from sliding out of the channels 514.

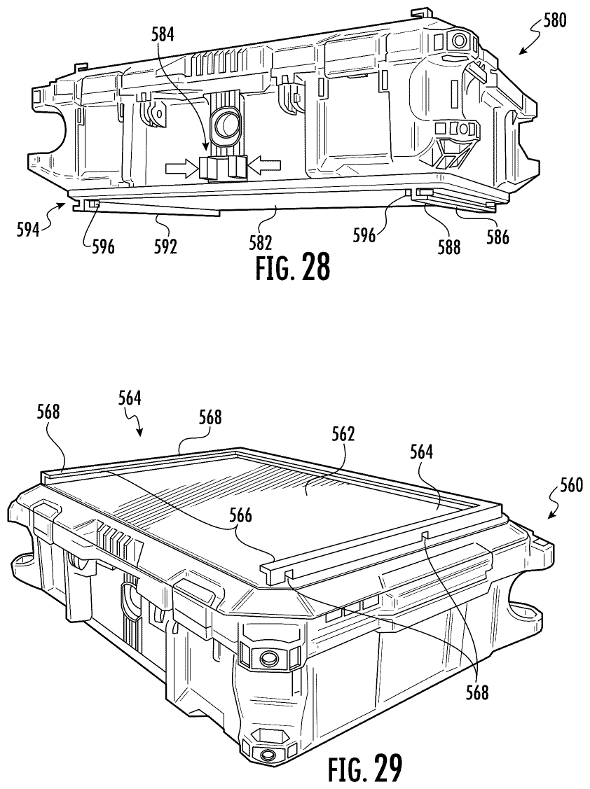

Referring to FIGS. 28-29, various aspects of utility module(s) are shown. Utility module 560 includes upper surface 562, rails 564 extending from upper surface 562, and ledges 566 extending from rails 564 above upper surface 562. Utility module 580 includes lower surface 582, latch 584, rail 586 extending from lower surface 582, lip 588 extending from rail 586 offset from lower surface 582, rail 592 extending from lower surface 582, and lip 594 extending from rail 592 offset from lower surface 582.

To engage utility module 580 with utility module 560, rail 586 and rail 592 of utility module 580 are slid into engagement with rails 564 of utility module 560 until protrusions 596 engage with recesses 568. Alternatively, to engage utility module 580 with utility module 560, rail 586 and rail 592 of utility module 580 are slid into engagement with rails 564 of utility module 560 until a latch from one of utility module 560 and utility module 580 engages with the other utility module to bias the utility modules 560, 580 from sliding displacement.

In various embodiments, rail(s) 586 and rail(s) 592 extend around all or most (e.g., 75%) of a periphery of utility module 580. In various embodiments, rail(s) 586 and rail(s) 592 extend around a periphery of utility module 580 and/or across the central portions within the periphery.

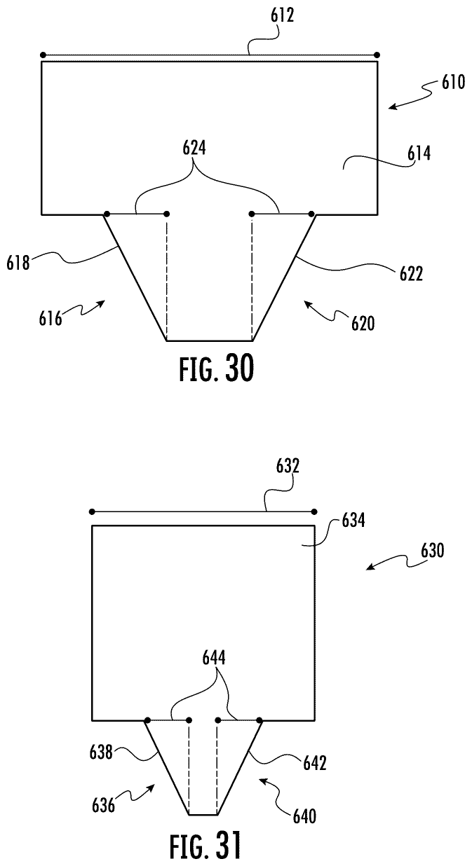

Referring to FIGS. 30-31, various aspects of couplers for utility module(s) are shown. Female coupler 610 includes recessed surface 614, left tab 616 and right tab 620 extending above recessed surface 614. Left tab 616 includes tapered edge 618, and right tab 620 includes tapered edge 622. In use, tapered edge 618 and tapered edge 622 define a width 624 that is a larger percentage of the width 612 of female coupler 610 compared to other female couplers, thereby facilitating engaging female coupler 610. In particular, the deeper pocket of female coupler 610 permits the user sliding male coupler into female coupler 610 to have a wider range of positions in which the male coupler will engage against one of tapered edges 618, 622, before sliding into the back of female couplers.

Referring to FIG. 31, female coupler 630 includes recessed surface 634, left tab 636 and right tab 640 extending above recessed surface 634. Left tab 636 includes tapered edge 638, and right tab 640 includes tapered edge 642. In use, tapered edge 638 and tapered edge 642 define width 644 that is a larger percentage of the width 632 of female coupler 630 compared to other female couplers, thereby facilitating engaging female coupler 630 with male couplers.

Referring to FIGS. 32-35, various aspects of utility module(s) are shown. Utility module 660 includes housing 662, lower surface 664, male couplers 666 extending from lower surface 664, front face 668, handle 670 extending from front face 668, and latch 672 extending from housing 662 below lower surface 664. Latch 672 is slidably actuated below lower surface 664 by handle 670.

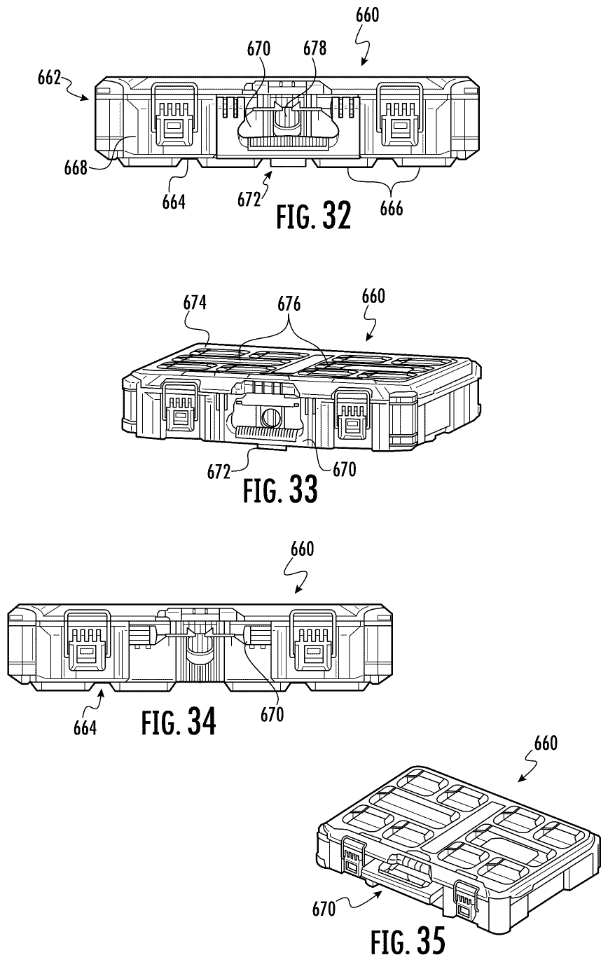

In use, utility module 660 is placed on another utility module, thereby engaging male couplers 666 with couplers of the other utility module, such as female couplers 676 on upper surface 674. Then handle 670 is pivoted downward (FIGS. 32-33) until latch 672 extends below lower surface 664, thereby preventing sliding disengagement of utility module 660 with the other utility module. To remove utility module, latch 672 is retracted, such as by a user pivoting handle 670 upward (FIGS. 34-35), thereby retracting latch 672 and permitting sliding disengagement of utility module 660 with the other utility module.

In various embodiments, latch 672 can be retracted by a user actuating interface 678 at the front of utility module 660, thereby retracting latch 672 and permitting sliding disengagement of utility module 660 with the other utility module.

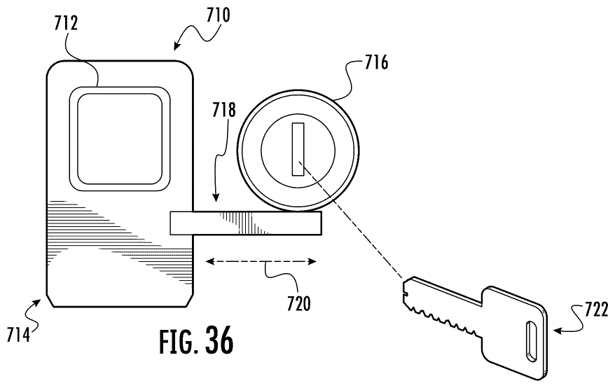

Referring to FIG. 36, various aspects of a component of utility module(s) are shown. Latch 710 of one or more utility modules includes aperture 712 and projection 714, the projection 714 extending downward from the utility module to prevent sliding disengagement with another utility module (e.g., see FIGS. 32-35).

Lock 716 includes arm 718 that selectively engages with projection 714 to prevent projection 714 from retracting. In various embodiments, arm 718 slides along axis 720 to engage and disengage with projection 714. A locking device, shown as key 722, actuates lock 716 between a locked and unlocked position. In the locked position, the arm 718 is not permitted to actuate between the locked and unlocked positions (e.g., slide along axis 720), thereby preventing disengagement of the utility module from another utility module. In the unlocked position, the arm 718 does not prevent disengagement of the utility module from another utility module.

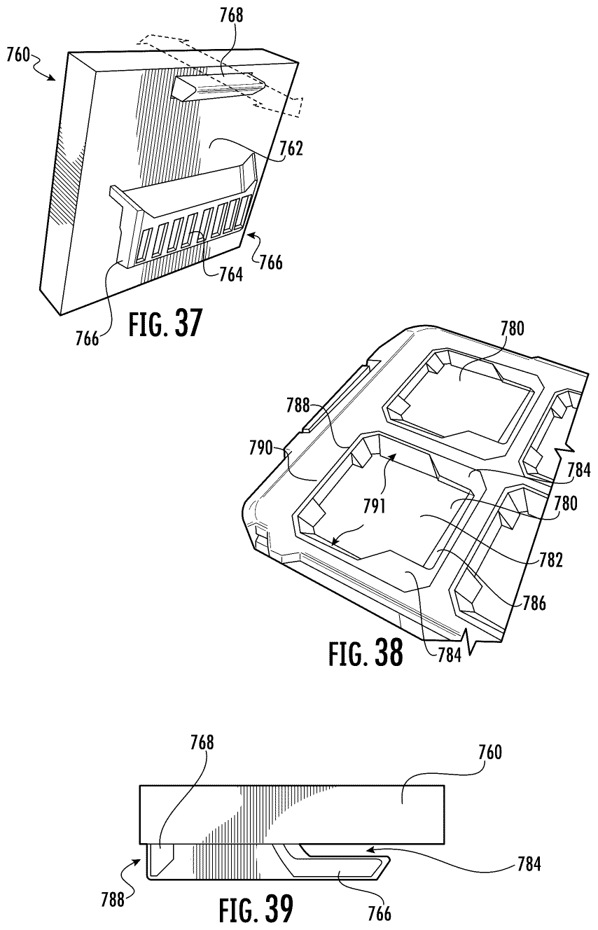

Referring to FIGS. 37-39, various aspects of couplers of utility module(s) are shown. Female coupler 780 includes recessed surface 782, tongues 784 extending above recessed surface 782, front wall 786, an opposing rear wall 788, and recess 790 within rear wall 788. Utility module 760 includes lower surface 762, male coupler 764 extending from lower surface 762, ribs 766 of male coupler 764 extending below and offset from lower surface 762, and latch 768 retractably extending from lower surface 762.

In use, male coupler 764 is engaged with female coupler 780 until ribs 766 are engaged with tongues 784. Then latch 768 is extended into recess 790 of rear wall 788, thereby preventing sliding disengagement of male coupler 764 and female coupler 780.

In various embodiments, a coupling assembly includes male coupler 764 and female coupler 780. Female coupler 780 includes depressed locking surface 782, a back wall 788, first side wall 791, a second side wall 791, a front wall 786 extending from the depressed locking surface 782, a first tongue 784 extending from the first side wall 791 and the back wall 788 above the depressed locking surface 782, and a second tongue 784 extending from the second side wall 791 and the back wall 788 above the depressed locking surface 782. First side wall 791 and the second side wall 791 both extend between the front wall 786 and the back wall 788.

Male coupler 764 is configured to detachably engage with the female coupler 780 such that the first utility module, on which female coupler 780 is located, and the second utility module, on which male coupler 764 are located, are detachably and rigidly engaged. Male coupler 764 includes a first rib 766, a second rib 766, and a retractable projection, shown as latch 768. First rib 766 is engageable with the first tongue 784 such that the first rib 766 engages between the first tongue 784 and the depressed locking surface 782, and the second rib 766 is engageable with the second tongue 784 such that the second rib 766 engages between the second tongue 784 and the depressed locking surface 782. Latch 768 is positionable in a locked position thereby limiting displacement of the first utility module with respect to the second utility module as a result of the latch 768 interfacing with the front wall 786 of the female coupler 780.

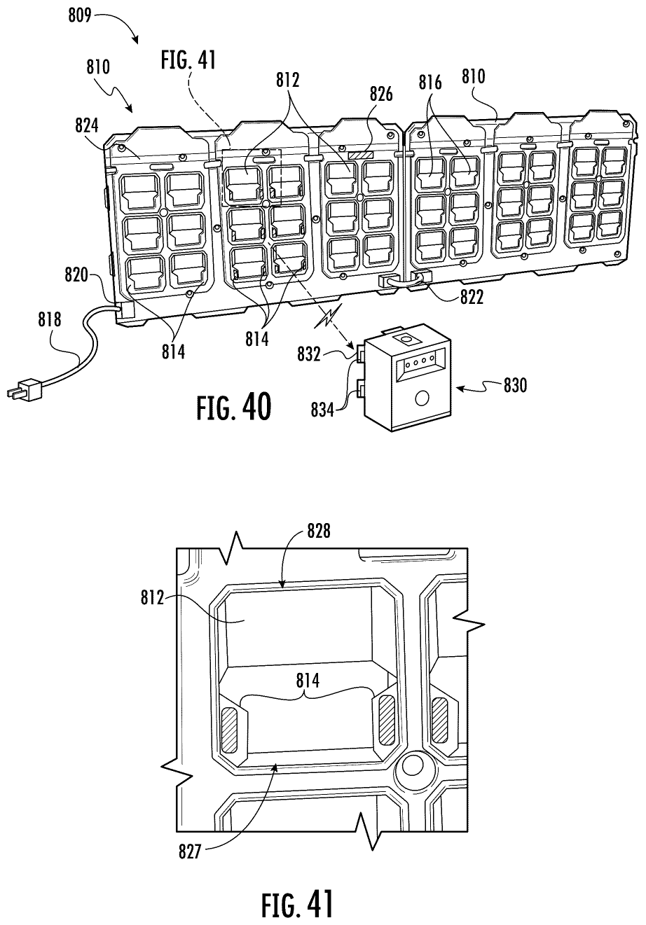

Referring to FIGS. 40-41, various aspects of components for use with utility module(s) for another modular system are shown. One or more plates 810 are provided that provide electrical current to utility modules. Plate 810 includes female couplers 812, charged tongues 814, uncharged tongues 816, a power input 820 that receives power from power cord 818, a connecting cord 822 that provides power between plates 810, a charged latch 826 and an uncharged latch 824. In use, charged latch 826 and charged tongues 814 provide power to utility modules coupled to plate 810 and interfacing with the respective charged latch 826 and charged tongues 814.

In various embodiments, power is transferred between plates 810, such as via connecting cord 822 and/or via edges of the plates interfacing to transfer power. In various embodiments, a single plate 810 is electrically coupled to an outlet and the remaining plate(s) 810 receive power from the plate that is electrically coupled to the outlet.

For example, utility module 830 is coupled to female couplers 812 with charged tongues 814 (FIG. 41). Utility module 830 includes male couplers 832 that include ribs 834 configured to received electrical power such as from charged tongues 814. When utility module 830 is coupled to female couplers with charged tongues 814, then utility module 830 receives and uses power, such as to recharge a rechargeable power tool battery and/or to send power to a power tool or lighting for immediate use.

In various embodiments, a support platform 809 includes one or more plates 810 configured to couple to a wall, an electrical input 820 coupled to the plate 810 and configured to receive electrical power, and a plurality of female couplers 812 defined by the plate 810. Each of the plurality of female couplers 812 includes sidewalls, a bottom wall 827 extending between the sidewalls, a top wall 828 extending between the sidewalls opposite the bottom wall 827, a first tongue 814 extending from the bottom wall 827 towards the top wall 828 and extending from a first sidewall towards the other second sidewall, a second tongue 814 extending from the bottom wall 827 towards the top wall 828 and extending from the second sidewall towards the first sidewall. The tongues 814 are in electrical communication with the electrical input 820, and the tongues 814 are configured to provide the electrical power from the electrical input 820 to an object coupled to the respective female coupler 812.

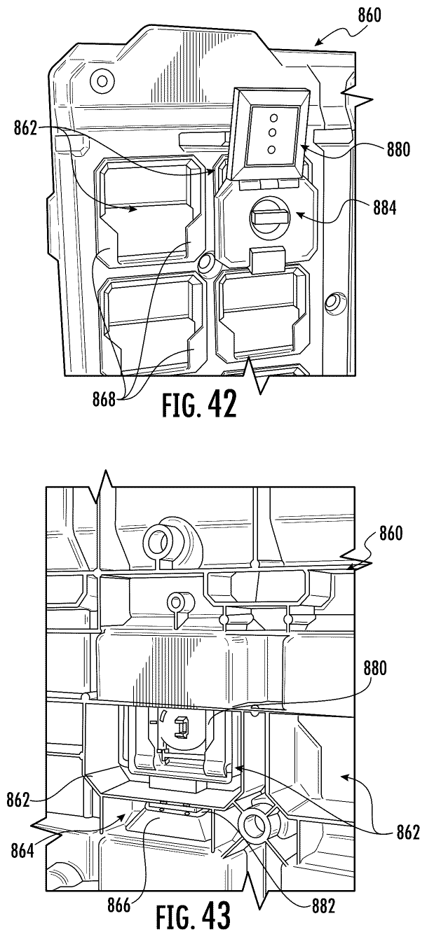

Referring to FIGS. 42-43, various aspects of components for use with utility module(s) of another modular system are shown. Plate 860 includes female couplers 862. Female couplers 862 include latch recess 864 configured to receive latch 882, power interface 866 configured to be in electrical communication with latch 882, and tongues 868.

Utility module 880 is coupled to female coupler 862 until latch 882 is extended within latch recess 864 to interface with power interface 866 via the user actuating latch interface 884 until latch 882 is extended. Then utility module 880 receives electrical power from plate 860, such as to recharge a rechargeable power tool battery and/or to send power to a power tool or lighting for immediate use.

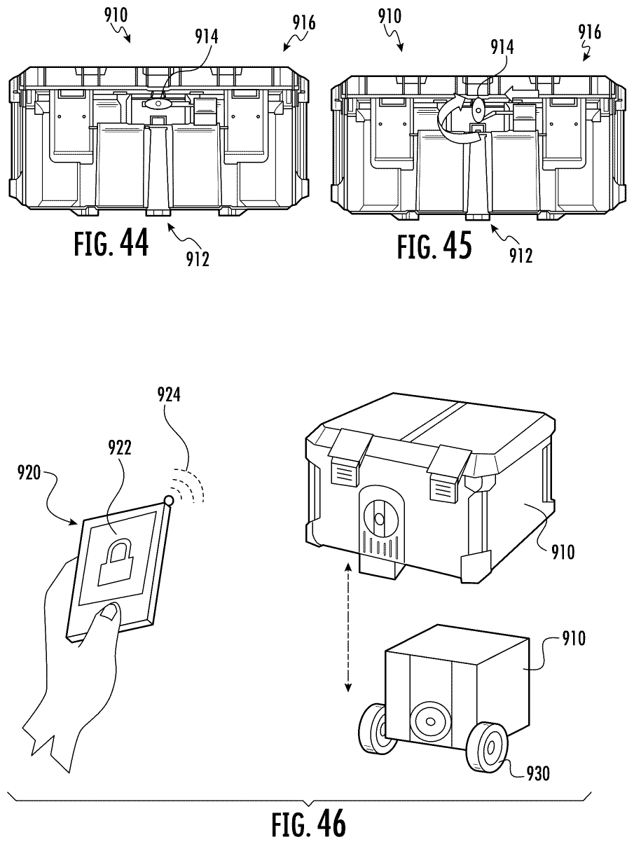

Referring to FIGS. 44-46, various aspects of utility module(s) for another modular system are shown. Described herein are utility modules that include electrical locking to prevent utility modules from being stolen and used off-property. Utility module 910 includes latch 912, lid 916, and lock 914. Lock 914 is actuated, such as rotationally, between a locked position and an unlocked position. In the locked position, lock 914 prevents lid 916 from being opened and prevents latch 912 from disengaging with another utility module. In particular, lock 914 prevents latch 912 from sliding upward, which is a first step to disengage with another utility module.

In various embodiments, lock 914 can be actuated by a personal mobile device, shown as cell phone 920, which includes application 922. Application 922 can selectively send a signal 924 to lock 914 to actuate between the locked and unlocked positions. In various embodiments, a computer platform 930, such as a server, monitors all utility modules including locks 914. In various embodiments, the lock 914 and/or the utility module that lock 914 is coupled to is monitored to confirm the lock 914 and/or the utility module is still within a geofence, and when the lock 914 and/or the utility module leaves the identified area (e.g., traverses a wall of the geofence) then the lock 914 is engaged to prevent access to the associated utility module until the utility module is brought back within the geofenced area.

In various embodiments, a coupler (e.g., coupler 1180 coupled to rail 1112 coupled to utility module 120) is supported from a first utility module 910, the first utility 910 including a lid 916, a latch 912, and a lock 914. The lock 914 actuates between a locked position and an unlocked position. The lock 914 prevents the lid 916 from being opened and the latch 912 from disengaging from another utility module when the lock is in the locked position.

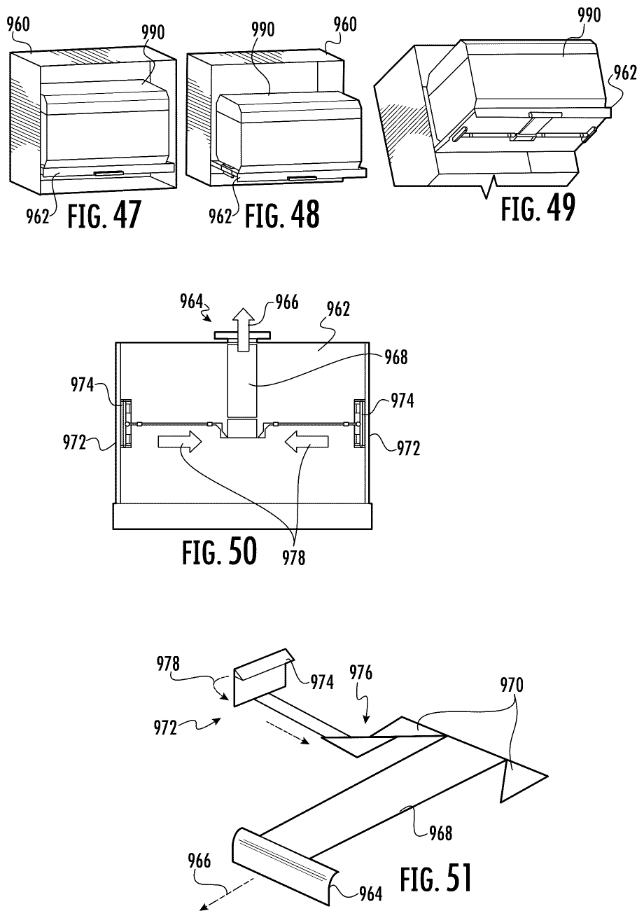

Referring to FIGS. 47-51, various aspects of a support unit for utility module(s) are shown. Support unit 960 includes one or more shelves 962 slidable with respect to the housing. The shelf can be pulled in direction 966 to extend shelf 962 from the housing when a utility module 990 is coupled to and on top of shelf 962.

As will be explained, utility module 990 is coupled to shelf 962 until the user pulls on handle 964, which disengages shelf 962 from utility module 990. Shelf 962 includes arm 968 extending from handle 964, the arm 968 rigidly coupled to ledges 970 that slidably engage with cam surfaces 976. In use, pulling handle 964 in direction 966 biases tongue 974 of coupler to rotate in direction 978 to disengage the coupler 972 of shelf 962 from ribs of utility module 990, thereby disengaging the utility module 990 from the shelf 962.

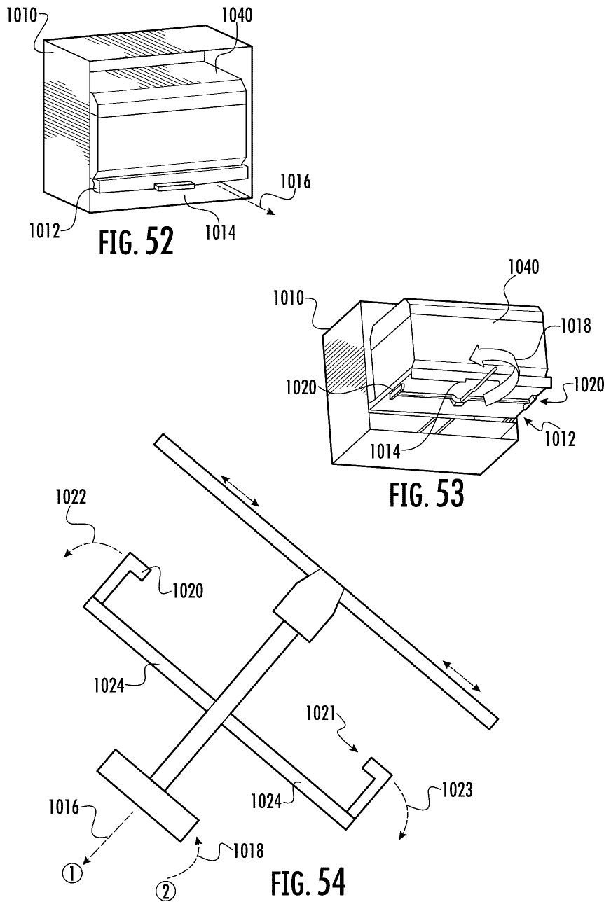

Referring to FIGS. 52-54, various aspects of a support unit for utility module(s) are shown. Support unit 1010 includes one or more shelves 1012 slidable with respect to the housing of support unit 1010.

Shelf 1012 includes handle 1014 that is pulled in direction 1016 to extend shelf 1012, thereby releasing shelf 1012 from its storage position. Shelf 1012 is detachably engaged with utility module 1040. To disengage shelf 1012 from utility module 1040, the handle is rotated in direction 1018, which causes arms 1024 to move towards each other. This causes tongue 1020 to rotate in direction 1022 and tongue 1021 to rotate in direction 1023, thereby disengaging tongues 1020, 1021 from utility module 1040 and permitting utility module 1040 to be removed from shelf 1012.

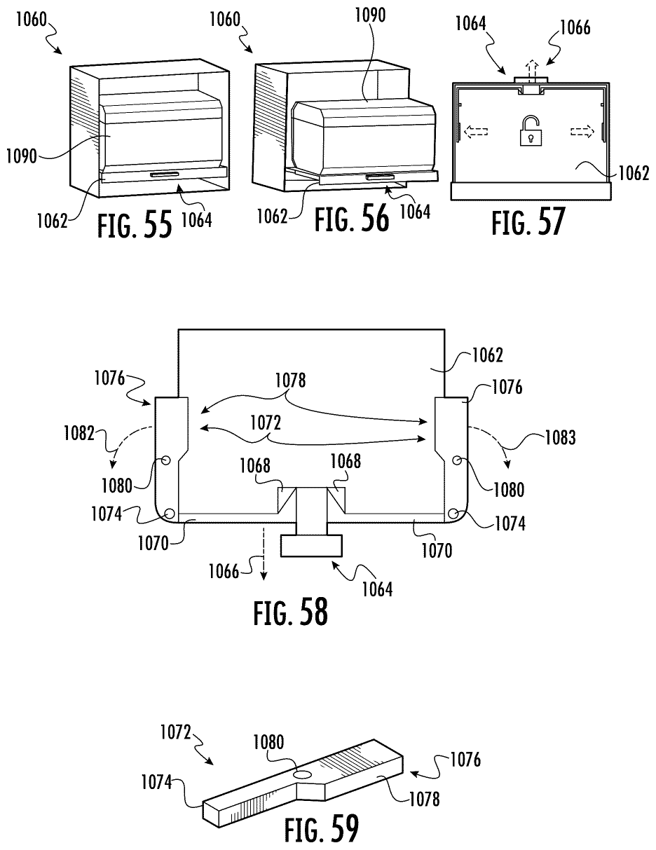

Referring to FIGS. 55-59, various aspects of a support unit for utility module(s) are shown. Support unit 1060 includes shelves 1062 that detachably engage with utility module 1090.

In use, when handle 1064 of shelf 1062 is pulled in direction 1066, cam surface 1068 engages with arms 1070 to bias arms 1070 towards handle 1064. Arms 1070 are coupled to couplers 1072, and couplers 1072 are detachably engaged with utility module 1090. First end 1074 of coupler 1072 is engaged with arms 1070, and second end 1076 of coupler 1072 opposite first end 1074 engages with utility module 1090. When handle 1064 is pulled in direction 1066, first end 1074 is pulled towards handle 1064, thereby rotating coupler 1072 around axis 1080 in directions 1082, 1083 to disengage couplers 1072 from utility module 1090.

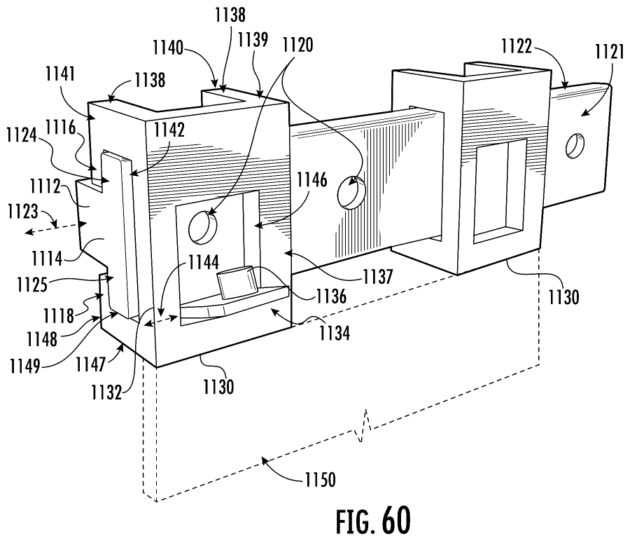

Referring to FIG. 60, various aspects of a rail for utility module(s) are shown. Described herein are methods for biasing objects coupled to rail 1112 from sliding with respect to rail 1112, thereby providing a more stable engagement between rail 1112 and utility module(s).

Rail 1112 includes body 1114 defining an upper recess 1116, a lower recess 1118, and recess 1120. In use, a utility module (e.g., a storage device, a support device) includes one or more couplers 1130 that are coupled to rail 1112. Couplers 1130 include body 1132, clip 1134 pivotally coupled to body 1132, and projection 1136 extending from clip 1134. In use, a utility module including couplers 1130 is coupled to rail 1112, and when the utility module is in the correct position one or more of projections 1136 are pivoted into engagement with recess 1120.

Rail 1112 extends longitudinally along longitudinal axis 1123 and includes front surface 1121 and an upper surface 1122 that is above and extends from the front surface 1121 of the rail 1112. Rail 1112 includes an upper portion 1124 and lower portion 1125.

Coupler 1130 is for support platforms, such as support platform 1150, which is configured to hold one or more objects, such as tools and/or equipment. Coupler 1130 includes front wall 1137 configured to engage against front surface 1121 of rail 1112, upper arm 1138 extending from the front wall 1137, the upper arm 1138 configured to engage against upper surface 1122, rear higher arm 1141, and clip 1134 pivotally coupled to the front wall 1137. Upper arm 1138 extends from a first end 1139 at front wall 1137 to second end 1140 opposite the first end 1139. Rear higher arm 1141 extends from the second end 1140 of the upper arm 1138. Rear higher arm 1141, upper arm 1138, and front wall 1137 collectively define an upper channel 1142 within which an upper portion 1124 of the rail 1112 slides with respect to the front wall 1137.

Clip 1134 actuates with respect to the front wall 1137 between a locked position and an unlocked position. Clip 1134 includes a projection 1136 that engages within a recess 1120 defined by the front surface 1121 of the rail 1112 when the clip 1134 is in the locked position. Clip 1134 biases the front wall 1137 from sliding with respect to the rail 1112 when the clip 1134 is in the locked position. Clip 1134 pivots with respect to the front wall 1137 about a rotational axis 1144, and the rail 1112 extends longitudinally along longitudinal axis 1123, and the rotational axis 1144 and the longitudinal axis 1123 are parallel.

In various embodiments, projection 1136 defines a cylindrical shape. In various embodiments, each of recess 1120 and projection 1136 define a cylindrical shape.

In various embodiments, front wall 1137 defines an aperture 1146, and the clip 1134 is positioned at least partially within the aperture 1146. In various embodiments, clip 1134 extends at least partially past the front wall 1137 when the clip 1134 is in the unlocked position. In various embodiments, clip 1134 does not extend past the front wall 1137 when the clip 1134 is in the locked position.

Coupler 1130 includes lower wall 1147 extending from the front wall 1137, and a rear lower arm 1148 extending from the lower wall 1147. Front wall 1137, the lower wall 1147, and the rear lower arm 1148 collectively define a lower channel 1149 within which lower portion 1124 of the rail 1112 slides with respect to the front wall 1137. In various embodiments, projection 1136 pivots towards the upper portion 1124 of the rail 1112 when the clip 1134 actuates from the unlocked position to the locked position.

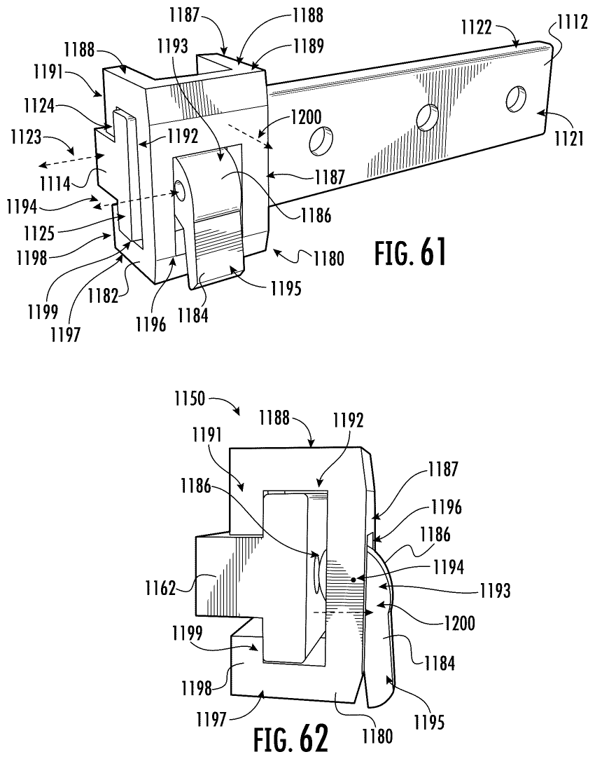

Referring to FIGS. 61-62, various aspects of a rail for utility module(s) are shown. Described herein are methods for biasing objects coupled to rail 1162 from sliding with respect to rail 1162, thereby providing a more stable engagement.

A utility module (e.g., a storage device, a support device) includes one or more couplers 1180 that are coupled to body 1164 of rail 1162. Couplers 1180 include body 1182 and clip 1184 pivotally coupled to body 1182. Clip 1184 includes cam surface 1186 interfaces against rail 1162 to increase friction between coupler 1180 and rail 1162. In use, a utility module including couplers 1180 is coupled to rail 1162, and when the utility module is in the correct position one or more of clips 1184 are pivoted such that the cam surface 1186 causes frictional engagement between coupler 1180 and rail 1162, thereby biasing coupler 1180 to remain stationary with respect to rail 1162.

Coupler 1180 is for support platforms, such as support platform 1150, which is configured to hold one or more objects, such as tools and/or equipment. Coupler 1180 includes front wall 1187 configured to engage against front surface 1121 of rail 1112, upper arm 1188 extending from the front wall 1187, the upper arm 1188 configured to engage against upper surface 1122, rear higher arm 1191, and clip 1184 pivotally coupled to the front wall 1187. Upper arm 1188 extends from a first end 1189 at front wall 1187 to second end 1190 opposite the first end 1189. Rear higher arm 1191 extends from the second end 1190 of the upper arm 1188. Rear higher arm 1191, upper arm 1188, and front wall 1187 collectively define an upper channel 1192 within which an upper portion 1124 of the rail 1112 slides with respect to the front wall 1137.

Clip 1184 actuates with respect to the front wall 1187 between a locked position and an unlocked position. Clip 1184 biases the front wall 1187 from sliding with respect to the rail 1112 when the clip 1184 is in the locked position. Clip 1184 pivots with respect to the front wall 1187 about a rotational axis 1194, and the rail 1112 extends longitudinally along longitudinal axis 1123, and the rotational axis 1194 and the longitudinal axis 1123 are parallel. When clip 1184 is in the locked position, coupler 1180 is biased in direction 1200 with respect to rail 1112 because the interface between the cam surface 1186 and the front surface 1121 biases the front wall 1187 in a first direction 1200 away from the rail 1112 when the clip 1184 is in the locked position.

In various embodiments, rail 1112 extends longitudinally along longitudinal axis 1123 that is perpendicular to first direction 1200. In various embodiments, clip 1184 pivots with respect to front wall 1187 about a rotational axis 1194 that is perpendicular to first direction 1200.

In various embodiments, front wall 1187 defines an aperture 1196, and the clip 1184 is positioned at least partially within the aperture 1196. In various embodiments, clip 1184 extends at least partially past the front wall 1187 when the clip 1184 is in the unlocked position and the locked position.

Clip 1184 includes a body 1193 and an arm 1195 extending from the body 1193, the body 1193 defining cam surface 1186. Body 1193 and the arm 1195 rotate about a first axis 1194 with respect to the front wall 1187 when the clip 1184 pivots with respect to the front wall 1187. Cam surface 1186 interfaces against the front surface 1111 of the rail 1112 when the clip 1184 is in the locked position. Clip 1184 biases the front wall 1187, and all of coupler 1180, from sliding with respect to the rail 1112 when the clip 1184 is in the locked position.

Coupler 1180 includes lower wall 1197 extending from the front wall 1187, and a rear lower arm 1198 extending from the lower wall 1197. Front wall 1187, the lower wall 1197, and the rear lower arm 1198 collectively define a lower channel 1199 within which lower portion 1124 of the rail 1112 slides with respect to the front wall 1187.

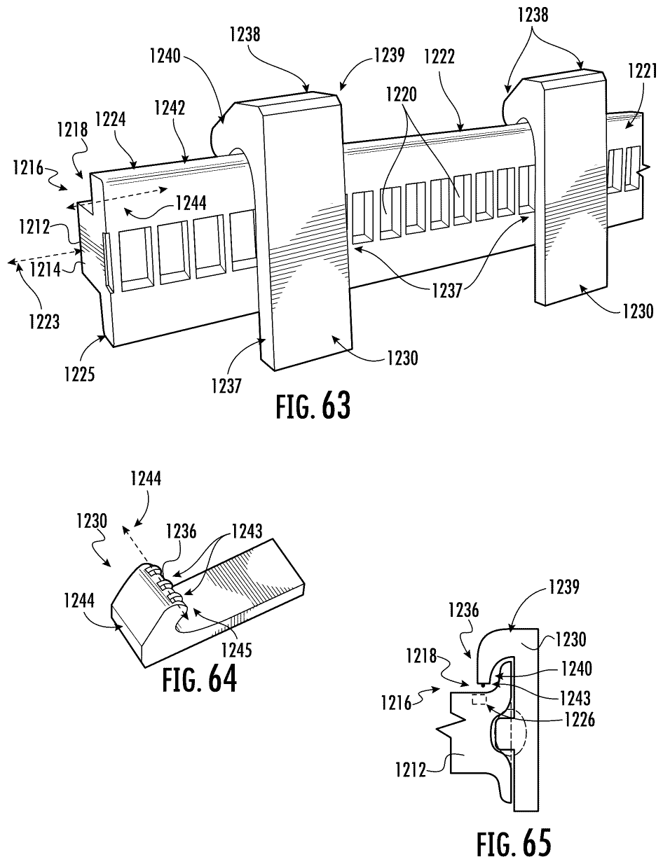

Referring to FIGS. 63-65, various aspects of a rail for utility module(s) are shown. Described herein are methods for biasing objects coupled to rail 1212 from sliding with respect to rail 1212, thereby providing a more stable engagement.

Rail 1212 includes body 1214 defining upper recess 1216 behind body 1214, upper surface 1218, and apertures 1220. A utility module (e.g., a storage device, a support device) includes one or more couplers 1230 that are coupled to rail 1212. Couplers 1230 include clip 1232, upper arm 1234 that engages around upper surface 1218 and into upper recess 1216, and engaging surface 1236 that engages against upper surface 1218 of rail 1212. In various embodiments, upper arm 1234 includes one or more ribs that increase frictional engagement between upper arm 1234 and rail 1212. In various embodiments, clip 1232 engages with an aperture 1220 to bias coupler 1230 from sliding with respect to rail 1212.

Rail 1212 extends longitudinally along longitudinal axis 1223 and includes front surface 1221 and an upper surface 1222 that is above and extends from the front surface 1221 of the rail 1212. Rail 1212 includes an upper portion 1224 and lower portion 1225. As will be explained, rail 1212 includes recesses 1226 configured to interface with projections to bias clips against sliding with respect to rail 1212.

Coupler 1230 is for support platforms, such as support platform 1150, which is configured to hold one or more objects, such as tools and/or equipment. Coupler 1230 includes front wall 1237 configured to engage against front surface 1221 of rail 1212, upper arm 1238 extending from the front wall 1237, the upper arm 1238 configured to engage against upper surface 1222. Upper arm 1238 extends from a first end 1239 at front wall 1237 to second end 1240 opposite the first end 1239. Ribs 1243 extend from second end 1240, and interface with recesses 1226 in rail 1212. Upper arm 1238 and front wall 1237 collectively define an upper channel 1242 within which an upper portion 1224 of the rail 1212 slides with respect to the front wall 1237.

The plurality of ribs 1243 are configured to engage with recesses 1226 defined by the rail 1112 to bias the front wall 1237 from sliding with respect to the rail 1112. The plurality of ribs 1243 are arranged along a first axis 1244, and the rail 1112 extends along a longitudinal axis 1223, and the first axis 1244 is parallel to the longitudinal axis 1223.

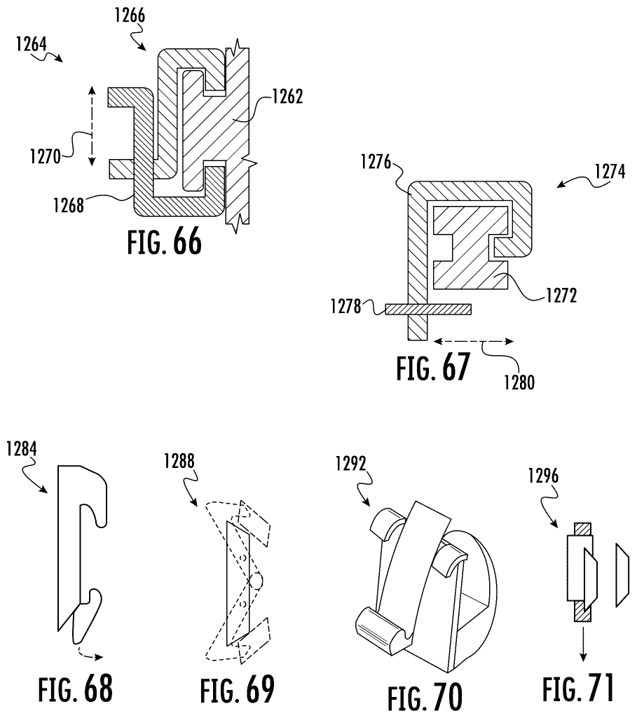

Referring to FIGS. 66-71, various aspects of rails for utility module(s) are shown. Described herein are methods for biasing objects coupled to rails 1262, 1272 from sliding with respect to rail 1262, 1272, thereby providing a more stable engagement.

Referring to FIG. 66, coupler 1264 is coupled to rail 1262. Coupler 1264 includes upper panel 1266, lower panel 1268 slidably coupled to upper panel 1266. Lower panel 1268 slides with respect to upper panel 1266 along axis 1270. In use, a user slides lower panel 1268 downward until coupler 1264 is engaged with rail 1262, and then lower panel 1268 is spring biased upward with respect to upper panel 1266 to engage against rail 1262.

Referring to FIG. 67, coupler 1274 is coupled to rail 1272. Coupler 1274 includes upper panel 1276, lower panel 1278 slidably coupled to upper panel 1276. Lower panel 1278 slides with respect to upper panel 1276 along axis 1280. In use, a user slides lower panel 1278 to the retracted position (e.g., to the left from the perspective of FIG. 67), engages upper panel 1276 against rail 1272, and then releases lower panel 1278 to be extended (e.g., to slide to the right from the perspective of FIG. 67 with respect to upper panel 1276).

Referring to FIGS. 68-71, various other couplers for engaging with rails are provided. Referring to FIG. 68, coupler 1284 includes lower hook pivotally coupled to the body, the hook and body collectively engaging against a rail. Referring to FIG. 69, coupler 1288 includes two hooks pivotally coupled to the body, the two hooks collectively engaging against a rail. Referring to FIG. 70, coupler 1292 includes a moving hook pivotally coupled to a body below two fixed hooks, and the moving hook and two fixed hooks collectively engage the rail. Referring to FIG. 71, coupler 1296 includes a lower hook slidably engaged with a body below a fixed hook, the lower hook and fixed hook collectively engaging the rail.

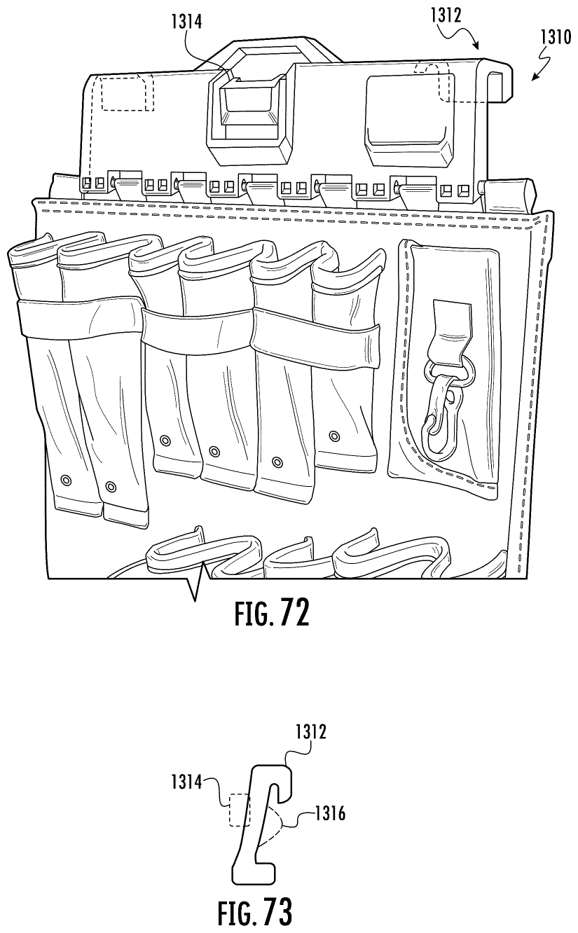

Referring to FIGS. 72-73, various aspects of a support platform for utility module(s) are shown. In various embodiments, support platform 1310 includes a single touchpoint for users to disengage support platform 1310 from a rail.

Support platform 1310 includes arm 1312 that engages with a support device, such as a rail. Support platform 1310 includes latch 1314 that slidably actuates protrusions 1316. Protrusion 1316 engages with rail to thereby bias support platform 1310 from sliding with respect to the rail. Applicant has observed that including a single latch 1314 in various embodiments facilitates users decoupling the support platform 1310 from the rail compared to other support platforms that include multiple latches, thereby requiring a user to decouple the multiple latches at the same time.

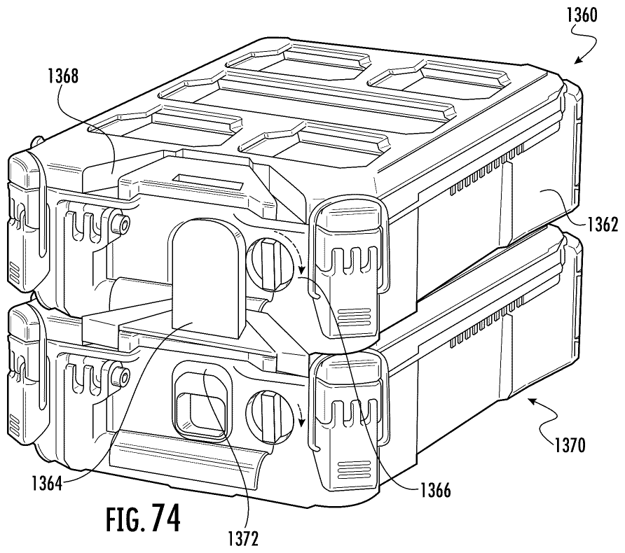

Referring to FIG. 74, various aspects of utility module(s) are shown. System 1360 includes utility module 1362 and utility module 1370. Utility module 1362 includes latch 1364 interface 1366, and channel 1368. Utility module 1370 includes latch recess 1372. In use, a user actuates interfaces 1366 to extend and retract latch 1364 within latch recess 1372.

When latch 1364 is extended within latch recess 1372, electrical power can be transferred between utility module 1362 and utility module 1370. As a result, a stacked arrangement of utility modules may include a power supply unit that provides power to one or more utility modules within the stack, such as to charge rechargeable power tool batteries.

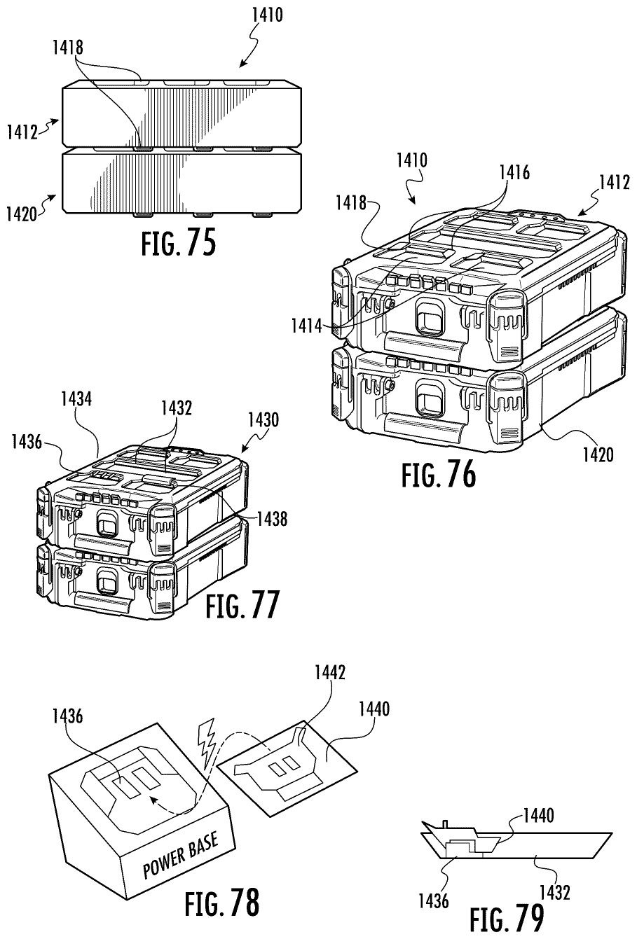

Referring to FIGS. 75-79, various aspects of utility module(s) are shown. System 1410 includes utility module 1412, utility module 1420 and utility module 1430. Utility module 1412 includes female coupler(s) 1414, each of which include one or more ribs 1416, and electrical interface 1418. In use, one or more of ribs 1416 include an electrical interface 1418, such as on a lower surface of the ribs 1416. In this way, utility module 1412 can provide power to other utility modules.

Referring to utility module 1430, various alternative methods of transferring power between utility modules are provided. In particular, utility module 1430 includes female coupler 1432 including ribs 1434 extending above and offset from a depressed surface. Electrical interfaces 1436 and/or electrical interfaces 1438 are in the back and rear of female couplers 1432 below and extending between ribs 1434. Electrical interfaces 1436 extend from the depressed surface of the female coupler 1432, and electrical interfaces 1438 extend from the rear wall of female couplers 1432.

Referring to FIGS. 78-79, male couplers 1440 include electrical interface(s) 1442. Male coupler 1440 detachably couples to female coupler 1432 and electrical interface 1442 of male couplers 1440 are electrically coupled to electrical interfaces 1436 of female couplers 1432, thereby permitting electrical power to be transferred between utility module 1430 and the utility module including male coupler 1440.

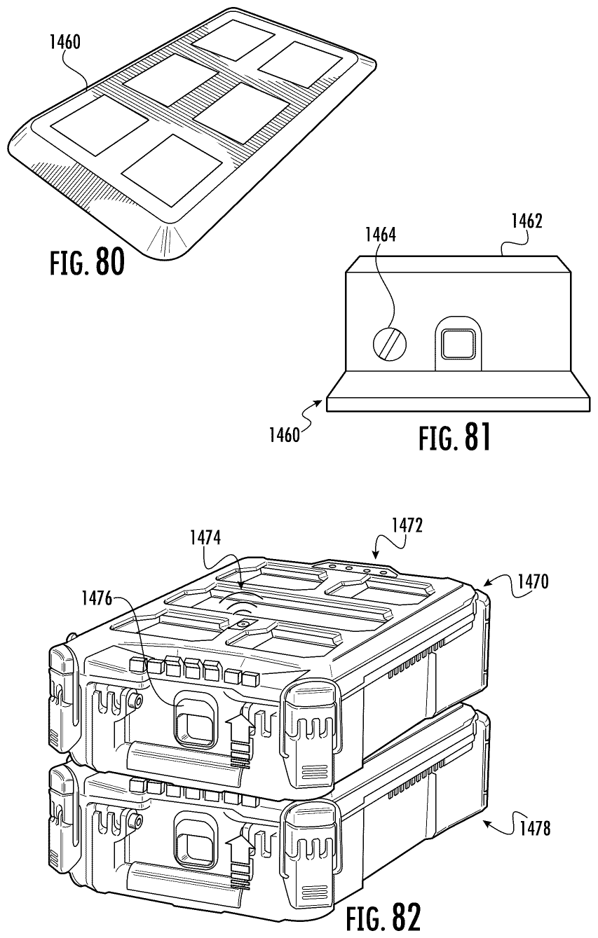

Referring to FIGS. 80-82, various aspects of utility module(s) are shown that facilitate transferring electrical power between utility modules. Support panel 1460 and utility module 1462 are coupled together, and interface 1464 on utility module 1462 is actuated to couple utility module 1462 to support panel 1460.

When utility module 1470 is coupled to utility module 1478, latch 1476 from utility module 1470 is extended into and engaged against utility module 1478 to prevent sliding disengagement between the male and female couplers. Utility module 1470 includes electrical system 1472 to facilitate electrical transfer between utility modules. Utility module 1470 includes chip 1474 to detect when another utility module is nearby utility module 1470. When another utility module 1470 is near chip 1474, utility module 1470 permits electrical power to be transferred to and/or from utility module 1470.

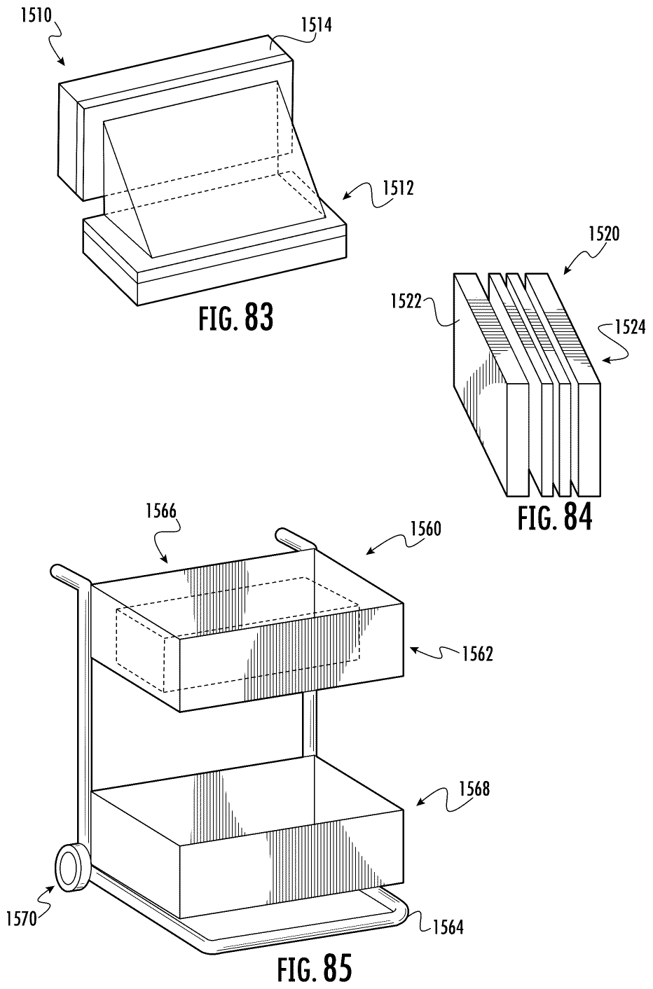

Referring to FIGS. 83-84, various aspects of coupling utility module(s) are shown. Coupling unit 1510 includes plate 1512 with couplers and plate 1514 with couplers. The couplers on each of plate 1512 and plate 1514 are the same (e.g., both female couplers with depressed surfaces and ribs extending above and offset from the depressed surface, or both male couplers with projections extending from the surface and two tongues extending from the projections that engage the ribs of female couplers). In various embodiments plate 1512 and plate 1514 are perpendicular to each other, thereby facilitating coupling utility modules at a 90 degree angle with respect to each other.

Coupling unit 1520 includes plate 1522 with couplers and plate 1524 with couplers. Couplers on each of plates 1522, 1524 are the same type of couplers (e.g., both female couplers with depressed surfaces and ribs extending above and offset from the depressed surface, or both male couplers with projections extending from the surface and two tongues extending from the projections that engage the ribs of female couplers). As a result, coupling unit 1520 permits the user to reverse the orientation of a system of utility modules coupled together (e.g., instead of female couplers facing upward, male couplers face upward because coupling unit 1520 includes male couplers and is coupled to the top of a utility module).

Referring to FIG. 85, various aspects of a transportation unit for utility module(s) are shown. Transportation unit 1560 includes upper support 1562 and lower support 1564. Utility module 1566 is engaged to and supported within upper support 1562, and utility module 1568 is engaged to and supported within lower support 1564. Wheels 1570 facilitate a user moving transportation unit 1560, such as by rolling. In various embodiments, utility module 1566 and utility module 1568 are slid out of the transportation unit 1560.

In various embodiments, a coupler (e.g., coupler 1180 coupled to rail 1112 coupled to utility module 120) is supported from a first utility module 1566 coupled to a transportation unit 1560 including an upper support 1562 and a lower support 1564, the first utility module 1566 coupled to the upper support 1562 while a second utility module 1568 is simultaneously coupled to the lower support 1564, the transportation unit 1560 including wheels 1570 to facilitate a user moving the transportation unit 1560.

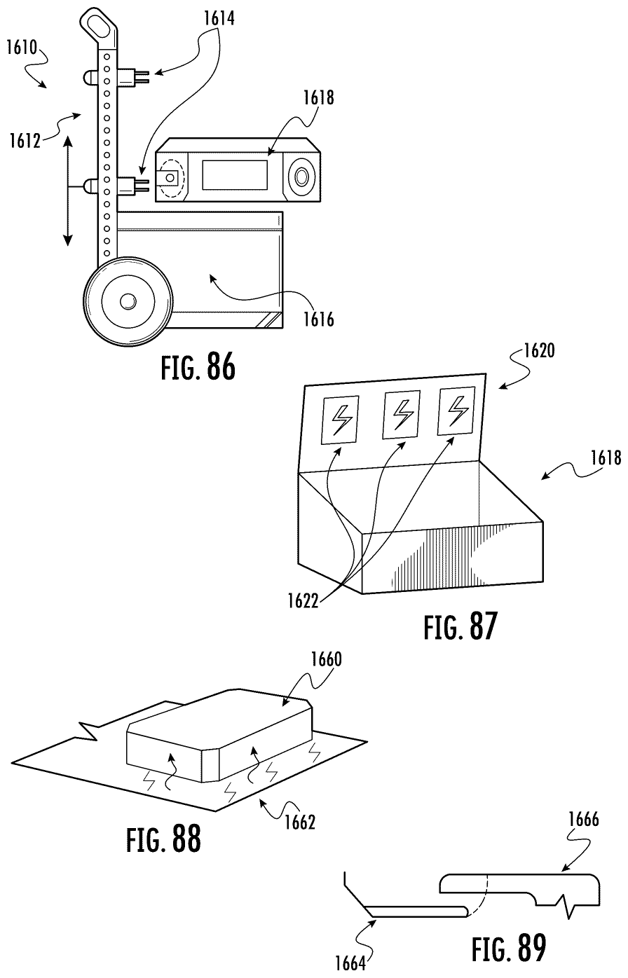

Referring to FIGS. 86-87, various aspects of a transportation and power supply system for utility module(s) are shown. System 1610 includes handle 1612, plugs 1614 sliding vertically along handle 1612, and power unit 1616 coupled to handle 1612 and in electrical communication with plugs 1614. Utility module 1618 is coupled to system 1610 and plugged into one of plugs 1614, thereby providing power from power unit 1616 to utility module 1618. In various embodiments, utility module 1618 includes a lid 1620 including electrical outputs 1622, such as on the interior lower surface of lid 1620. In various embodiments, one or more of electrical outputs 1622 can provide power to recharge rechargeable power tool batteries.

Referring to FIGS. 88-89, various aspects of utility module(s) are shown. Utility module 1660 includes coupler 1664, and utility module 1662 includes coupler 1666. Coupler 1664 is engaged to coupler 1666 (FIG. 89), thereby detachably engaging utility module 1660 to utility module 1662 and providing the ability to transfer electrical power between the utility modules.

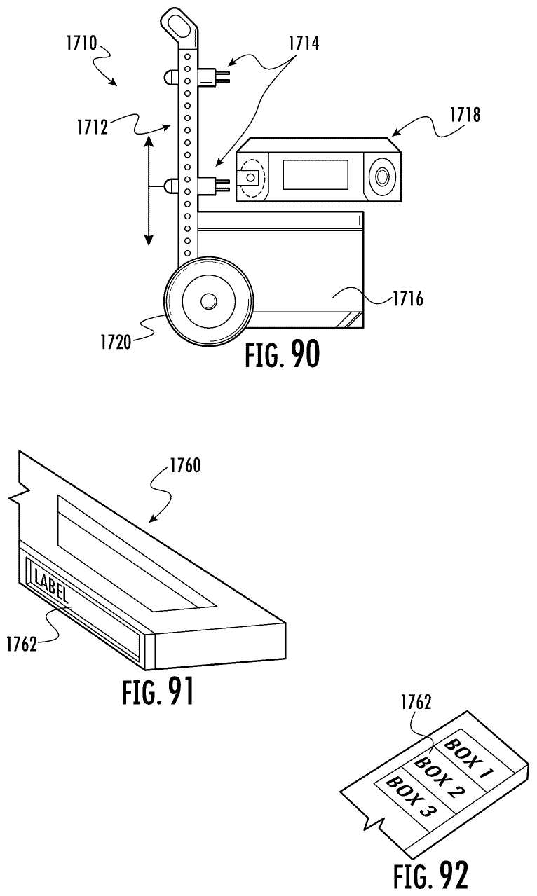

Referring to FIG. 90, various aspects of utility module(s) are shown. System 1710 includes handle 1712, plugs 1714 slidingly engaged with handle 1712, and power unit 1716 coupled to handle 1712 and electrically coupled to plugs 1714. Utility module 1718 is configured to receive electrical power from a rear of utility module 1718 through one of plugs 1714. Wheels 1720 facilitate moving system 1710.

Referring to FIGS. 91-92, various aspects of labels for storage and utility module(s) are shown. System 1760 includes label 1762 that displays contents of system 1760. In various embodiments, system 1760 tracks the contents via a touchable interface that can be updated by a user, geofencing so the system 1760 can track the location of system 1760 or contents of system 1760, and/or one key technology.

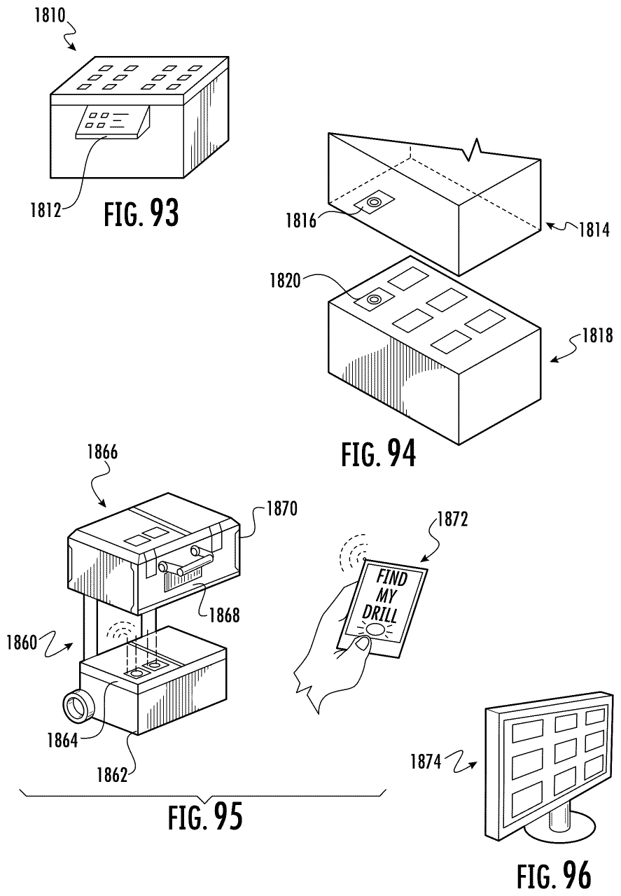

Referring to FIGS. 93-94, various aspects of utility module(s) are shown. When utility module 1810 is coupled to utility module 1818, electronics 1816 of utility module 1810 communicate with electronics 1820 of utility module 1818 to identify that the utility modules 1810, 1818 are coupled. Electronics 1816 and electronics 1820 communicate with each other, such as via wirelessly, to identify the contents of each utility module. Screen 1812 indicates the contents of one or more of utility module 1810 and utility module 1818.

Referring to FIGS. 95-96, various aspects of utility module(s) are shown that facilitate a user selecting utility modules, such as by utility modules being prepackaged with items for performing various types of work. Unit 1860 includes base 1862, electronics 1864 within base 1862, utility module 1866 including electronics 1868 and light 1870. When a user needs a certain tool, the user notifies the system, such as via a personal electronic device, such as a cell phone 1872, and cell phone 1872 notifies utility module 1866 to illuminate light 1870 because utility module 1866 includes the item. In this way, the user can more quickly find the item. Users can also track and/or find items by using a remote computer 1874 that communicates with unit 1860, such as wirelessly communicate.

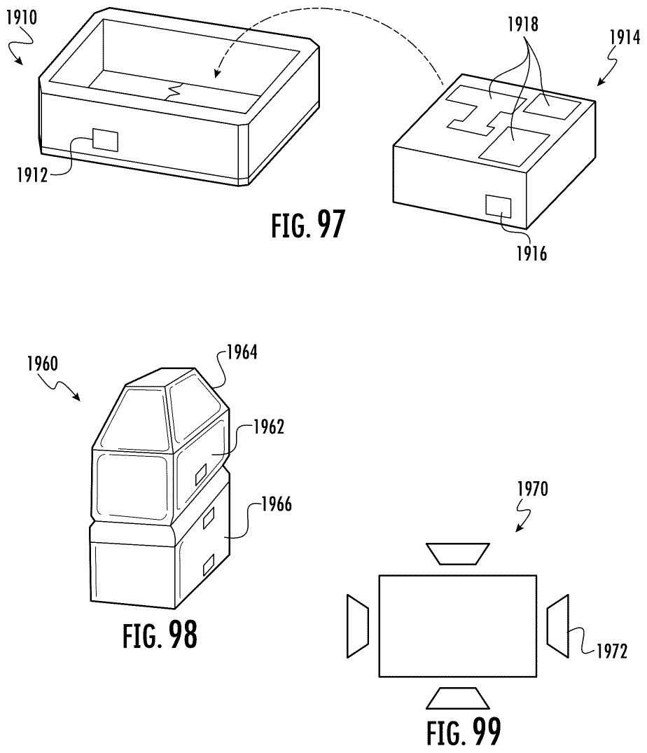

Referring to FIG. 97, various aspects of utility module(s) are shown that include prepackaged kits that include tools for certain types of work. Utility module 1910 includes electronics 1912, insert 1914, electronics 1916 in insert 1914, and recesses 1918 that receive certain tools. In use, when insert 1914 is placed within utility module 1910, electronics 1916 and electronics 1912 communicate with each other to let utility module 1910 know when tools are stored within insert 1914 and thus utility module 1910.

Referring to FIGS. 98-99, various aspects of utility module(s) are shown for security and inventory tracking. Utility module 1960 includes light sensor 1962, camera 1964, and controller 1966. Utility module 1970 includes camera 1964. Utility module 1970 includes a sensing device, such as a camera 1972. In use, light sensor 1962 and/or camera 1964 track what items are being moved near, into or out of utility module 1960. In various embodiments, one of utility module 1960 and/or utility module 1970 includes a power input that receives power, such as from a rechargeable power tool battery as a power backup. In various embodiments, utility module 1960 and utility module 1970 communicate with each other, such as wirelessly.

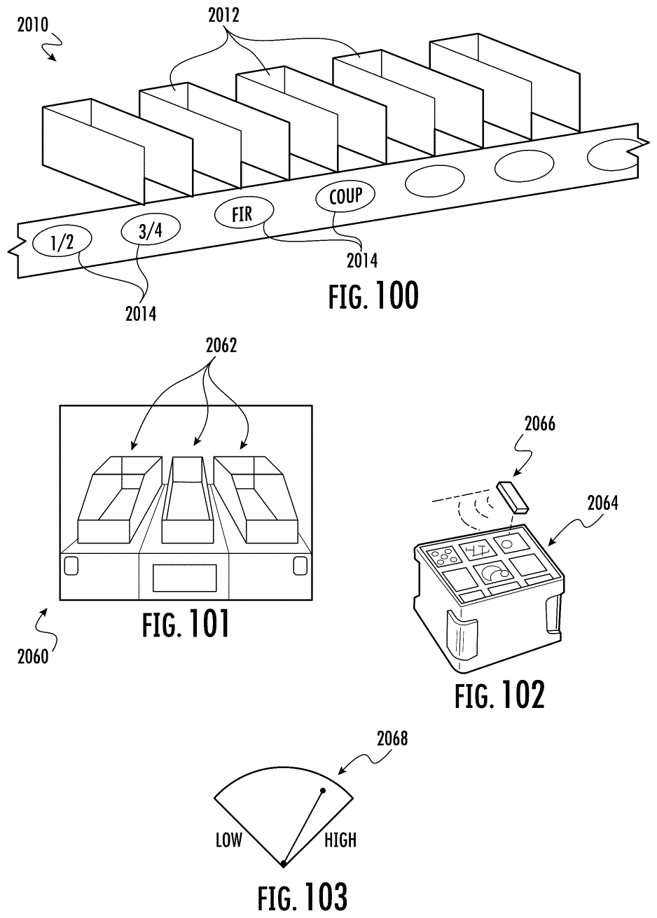

Referring to FIG. 100, various aspects of inventory tracking related to utility module(s) in another modular system are shown. Storage unit 2010 includes compartments 2012 and interface 2014. Interface 2014 includes screens and/or buttons that receive input and provide information to users, such as regarding the contents of each compartment 2012. In various embodiments, storage unit 2010 sends an alert when a compartment 2012 is running low on units and replacement units need to be ordered.

Referring to FIGS. 101-103, various aspects of inventory tracking related to utility module(s) are shown. Shelf 2060 includes compartments 2062. In use, shelf 2060 tracks the weight of each compartment 2062 and orders a resupply when the weight gets below a certain threshold (e.g., the shelf 2060 includes electronics that are programmed with the weight of the units in each compartment 2062, and shelf 2060 orders resupplies when the weight indicates fewer than X units remain, such as fewer than two units). Utility module 2064 includes scanner 2066 and display 2068. Scanner 2066 scans items being put within utility module 2064 and removed from utility module 2064.

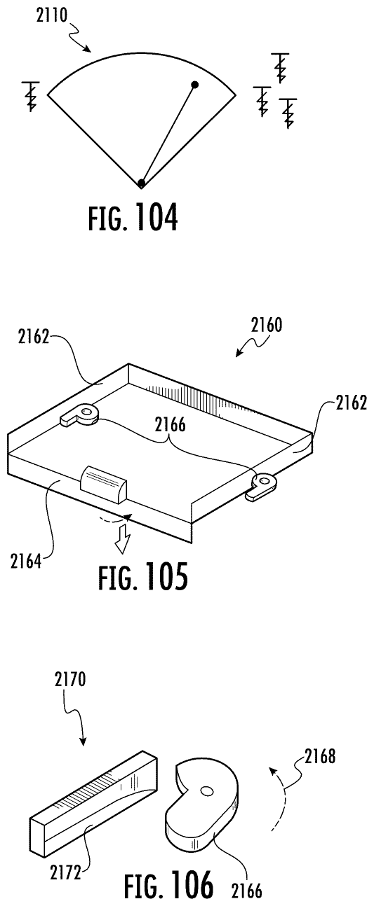

Referring to FIG. 104, various aspects of inventory tracking and searching related to utility module(s) are shown. In various embodiments, a user can scan contents of a container, such as a utility module, through RFID scanning, QR scanning, and/or barcode scanning. In use, the container may be scanned when the container is checked into a vehicle, a trailer, or a shop. In various embodiments, the container may be powered to facilitate being scanned (e.g., via powering internal electronics within the container). In various embodiments, the container includes a display 2110 that indicates how full the container is.

Referring to FIGS. 105-106, various aspects of a shelf for utility module(s) are shown. Shelf 2160 includes side wall 2162, front wall 2164, and cams 2166 that extend through one or both side walls 2162. Cams 2166 are spring-biased into the shelf 2160 in direction 2168 to engage a male coupler 2172 of utility module 2170 on shelf 2160. Front wall 2164 of shelf 2160 can be pivoted between a closed position (e.g., extending up) and an open position (extending forward and/or down) to permit utility module 2170 to be slidably removed from shelf 2160. In various embodiments, pivoting the front wall 2164 causes the cams 2166 to disengage from the male couplers 2172.

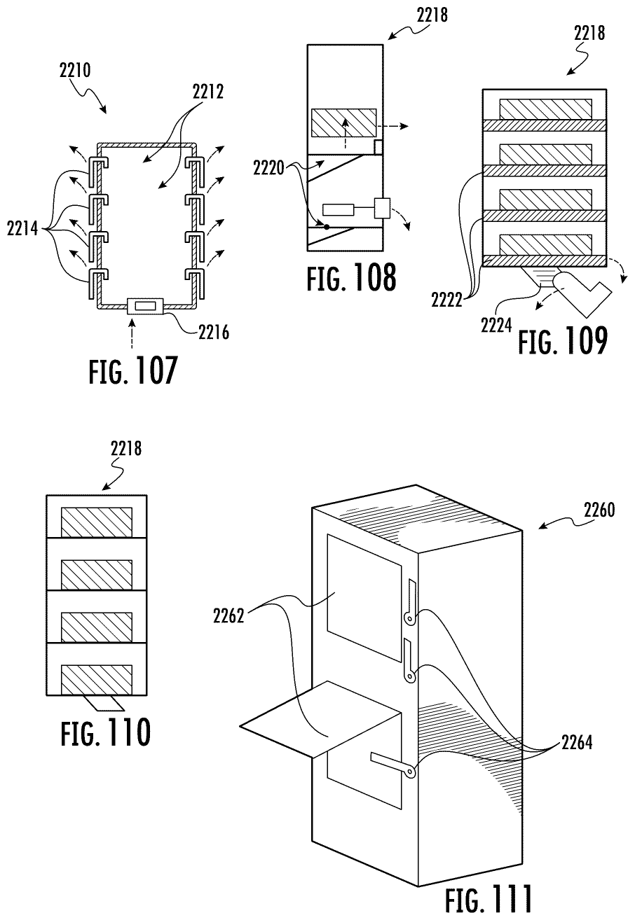

Referring to FIGS. 107-110, various aspects of storage of utility module(s) for another modular system are shown. Cabinet 2210 includes shelves 2212 and one or more latches 2214 by each shelf 2212. Latches 2214 detachably couple to utility modules stored on the shelves 2212. Pedal 2216 being pressed by a user disengages one or more latches 2214 (e.g., all of the latches 2214) to permit the utility modules on shelves 2212 to be removed.

Cabinet 2218 includes shelves 2220 and each shelf 2220 includes a lip 2222 that prevents utility module on the shelf 2220 from sliding forward and being removed. When a user presses pedal 2224, utility modules can be removed from shelves 2220, such as shelves being moved upward and/or lips pivoting down and forward so the lip is not in front of utility modules.

Referring to FIG. 111, various aspects of storage of utility module(s) are shown. Storage unit 2260 includes compartments 2262 and latches 2264. Latches 2264 are perpendicular to utility modules in compartments 2262, thereby facilitating securing utility modules in compartments 2262.

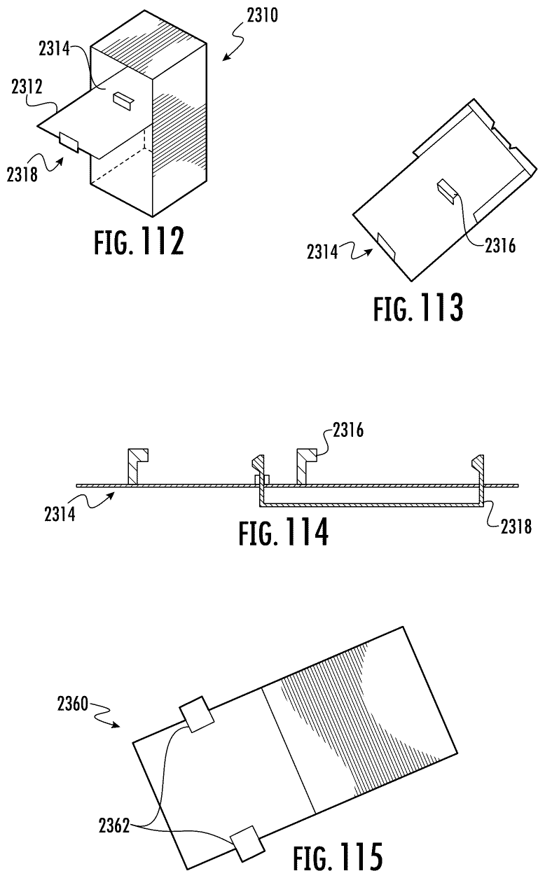

Referring to FIGS. 112-114, various aspects of storing utility module(s) are shown. Storage unit 2310 includes shelf 2312. Shelf 2312 includes fixed hook 2314, rotating hook 2316, and latch 2318. As a result of the multiple coupling elements included in shelf 2312, shelf 2312 permits a user coupling a full size utility module that covers the entire shelf 2312, or a half-size utility module that only covers half of shelf 2312. In particular, rotating hook 2316 can be rotated to either extend upward (FIG. 113) to permit half-sized units to be coupled to shelf 2312, or to be recessed within shelf 2312, thereby permitting a full size utility module to be coupled to shelf 2312.

Referring to FIG. 115, various aspects of storing utility module(s) are shown. Shelf 2360 includes latches 2362 that couple to a utility module on the shelf 2360. In use, a user can access latches 2362 to decouple latches 2362 from the utility module on the shelf 2360.

Referring to FIG. 116, various aspects of storing and supporting utility module(s) are shown. Platform 2410 includes couplers 2412. Accessory 2414 is coupled to couplers 2412, such as via extending across multiple couplers 2412.

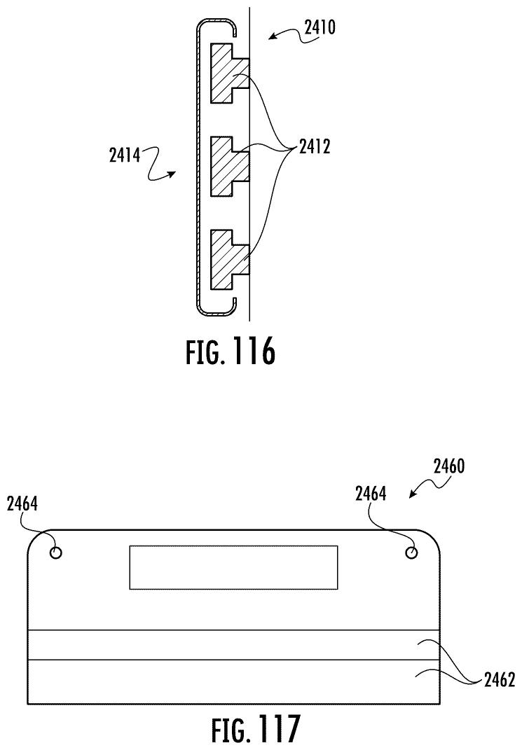

Referring to FIG. 117, various aspects of storing and/or supporting utility module(s) are shown. Platform 2460 includes rails 2462 to couple to utility modules, and apertures, shown as screw holes 2464 to facilitate coupling platform 2460 to a surface, such as a wall.

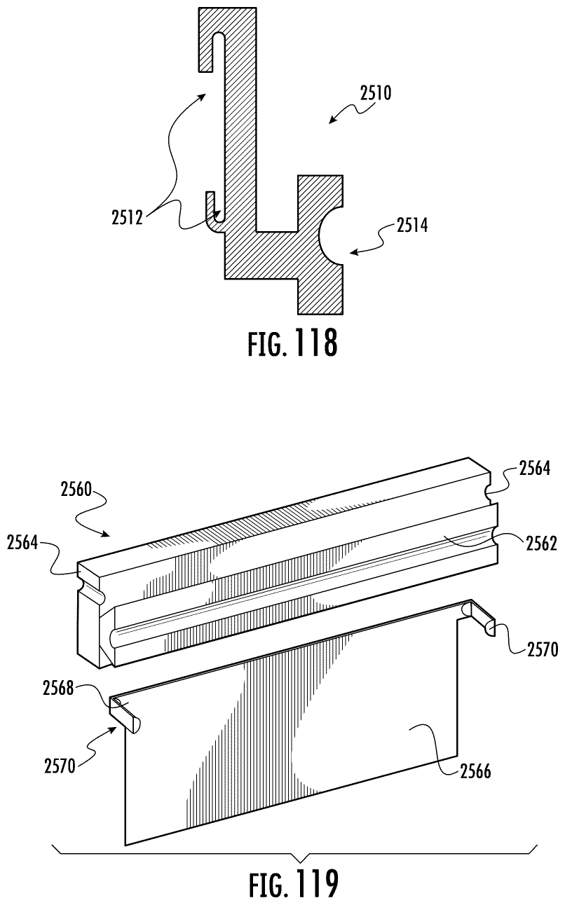

Referring to FIG. 118, various aspects of storing and/or supporting utility module(s) are shown. Support unit 2510 includes rear coupler 2512, that couples to a rail, and a front rail 2514. Support unit 2510 can be used to attach an internal rail to an outside rail.

Referring to FIG. 119, various aspects of storing and/or supporting utility module(s) are shown. Platform 2560 includes rail 2562 extending forward, and recess(es) 2564 on either side of platform 2560. Support unit 2566 is detachably coupled to platform 2560, such as via coupler 2568 engaging with rail 2562. Protrusion 2570 on support unit 2566 engages with recess(es) 2564 to bias the support unit 2566 to remain stationary with respect to platform 2560.

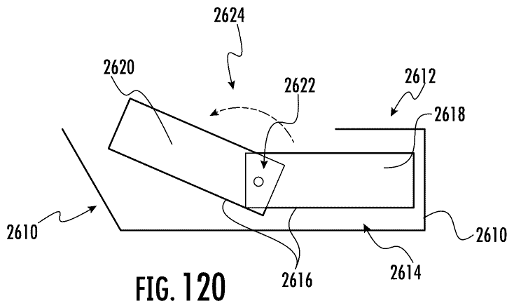

Referring to FIG. 120, various aspects of utility module(s) are shown. Female coupler 2610 includes ribs 2612 extending above and offset from recessed surface 2614. Male coupler 2616 includes front portion 2618, and rear portion 2620 pivotally coupled to front portion 2618 about axis 2622. In use, when male coupler 2616 is engaged with female coupler 2610, rear portion 2620 rotates in direction 2624 with respect to front portion 2618 around axis 2622.

In a specific embodiment, the coupling components, latches, and latch recesses are compatible with the coupling mechanism(s) described in International Patent Publication No. WO/2017/191628, which is hereby incorporated by reference in its entirety.

It is contemplated herein that the components and/or utility modules of various modular systems described herein may be used in conjunction and/or combination with components and/or utility modules of other modular systems.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A coupler for utility modules comprising:
a front wall configured to engage against a front surface of a rail, the rail extending longitudinally;
an upper arm extending from the front wall, the upper arm configured to engage against an upper surface of the rail that is above and extends from the front surface of the rail, the upper arm extending from a first end at the front wall to a second end opposite the first end;
a rear higher arm extending from the second end of the upper arm, wherein the rear higher arm, the upper arm, and the front wall collectively define an upper channel within which an upper portion of the rail slides with respect to the front wall; and
a clip pivotally coupled to the front wall, the clip actuating with respect to the front wall between a locked position and an unlocked position, the clip comprising a projection that engages within a recess defined by the front surface of the rail when the clip is in the locked position, wherein the clip biases the front wall from sliding with respect to the rail when the clip is in the locked position.

2. The coupler of claim 1, wherein the clip pivots with respect to the front wall about a rotational axis, and wherein the rail extends longitudinally along a longitudinal axis, and wherein the rotational axis and the longitudinal axis are parallel.

3. The coupler of claim 1, wherein the front wall defines an aperture, and wherein the clip is positioned at least partially within the aperture.

4. The coupler of claim 1, wherein the clip extends at least partially past the front wall when the clip is in the unlocked position.

5. The coupler of claim 4, wherein the clip does not extend past the front wall when the clip is in the locked position.

6. The coupler of claim 1, comprising a lower wall extending from the front wall, and a rear lower arm extending from the lower wall, wherein the front wall, the lower wall, and the rear lower arm collectively define a lower channel within which a lower portion of the rail slides with respect to the front wall.

7. The coupler of claim 1, wherein at least part of the projection is located past the front wall when the clip is in the unlocked position.

8. The coupler of claim 1, wherein the recess and the projection each define a cylindrical shape.

9. The coupler of claim 1, wherein the projection pivots towards the upper portion of the rail when the clip actuates from the unlocked position to the locked position.

10. A coupler for utility modules comprising:
a front wall configured to engage against a front surface of a rail, the rail extending longitudinally;
an upper arm extending from the front wall, the upper arm configured to engage against an upper surface of the rail that is above and extends from the front surface of the rail, the upper arm extending from a first end at the front wall to a second end opposite the first end;
a rear higher arm extending from the second end of the upper arm, wherein the rear higher arm, the upper arm, and the front wall collectively define a channel within which the rail slides with respect to the front wall, the upper arm, and the rear higher arm; and
a clip pivotally coupled to the front wall, the clip actuating with respect to the front wall between a locked position and an unlocked position, the clip comprising a body and an arm extending from the body, the body defining a cam surface, wherein the body and the arm rotate about a first axis with respect to the front wall when the clip pivots with respect to the front wall, wherein the cam surface interfaces against the front surface of the rail when the clip is in the locked position, wherein the clip biases the front wall from sliding with respect to the rail when the clip is in the locked position.

11. The coupler of claim 10, wherein the interface between the cam surface and the front surface biases the front wall in a direction away from the rail when the clip is in the locked position.

12. The coupler of claim 11, wherein the rail extends longitudinally along a longitudinal axis that is perpendicular to the first direction.

13. The coupler of claim 11, wherein the clip pivots with respect to the front wall about a rotational axis that is perpendicular to the first direction.

14. The coupler of claim 10, wherein the clip pivots with respect to the front wall about a rotational axis, and wherein the rail extends longitudinally along a longitudinal axis, and wherein the rotational axis and the longitudinal axis are parallel.

15. The coupler of claim 10, wherein the front wall defines an aperture, and wherein the clip is positioned at least partially within the aperture, and wherein the clip extends at least partially past the front wall when the clip is in the unlocked position.

16. The coupler of claim 15, wherein the interface between the cam surface and the front surface biases the front wall in a direction away from the rail when the clip is in the locked position.

17. The coupler of claim 15, wherein the clip extend past the front wall when the clip is in the locked position.

18. The coupler of claim 10, comprising a lower wall extending from the front wall, and a rear lower arm extending from the lower wall, wherein the front wall, the lower wall, and the rear lower arm collectively define a lower channel within which a lower portion of the rail slides with respect to the front wall.

19. A coupler for utility modules comprising:
a front wall configured to engage against a front surface of a rail, the rail extending longitudinally;
an upper arm extending from the front wall, the upper arm configured to engage against an upper surface of the rail that is above and extends from the front surface of the rail, the upper arm extending from a first end at the front wall to a second end opposite the first end; and
a plurality of ribs extending from second end, the plurality of ribs configured to engage with recesses defined by the rail to bias the front wall from sliding with respect to the rail.

20. The coupler of claim 19, wherein the plurality of ribs are arranged along a first axis, and wherein the rail extends along a longitudinal axis, and wherein the first axis is parallel to the longitudinal axis.

21. The coupler of claim 19, wherein the coupler is supported from a first utility module configured to detachably and rigidly couple with a second utility module when the first utility module slides in a first direction, wherein the first utility module is also configured to detachably and rigidly couple with the second utility module when the first utility module slides in a second direction perpendicular to the first direction, wherein the first utility module and the second utility module detachably and rigidly couple via cleats extending from the first utility module engaging with channels defined by the second utility channel.

22. The coupler of claim 19, wherein the coupler is supported from a first utility module configured to detachably and rigidly couple with a second utility module via male couplers extending from a lower surface of the first utility module rotatably engaging with female couplers defined by an upper surface of the second utility module.

23. The coupler of claim 19, wherein the coupler is supported from a first utility module configured to detachably and rigidly couple with a second utility module via protrusions extending from a lower surface of the first utility module slidably engaging with channels defined by an upper surface of the second utility module, the channels including a plurality of projections retractably extending into the channels, the plurality of projections configured to bias the protrusions from sliding out of the channels.

24. The coupler of claim 19, wherein the coupler is supported from a first utility module, the first utility comprising a lid, a latch, and a lock, the lock actuating between a locked position and an unlocked position, wherein the lock prevents the lid from being opened and the latch from disengaging from another utility module when the lock is in the locked position.

25. The coupler of claim 19, wherein the coupler is supported from a first utility module coupled to a transportation unit comprising an upper support and a lower support, the first utility module coupled to the upper support while a second utility module is simultaneously coupled to the lower support, the transportation unit comprising wheels to facilitate a user moving the transportation unit.
